(19) United States
(12) Patent Application Publication
(10) Pub. No.: US 2018/0035284 A1
(43) Pub. Date: Feb. 1, 2018

(54) COMMUNICATION SYSTEM

(71) Applicant: NEC CORPORATION, Tokyo (JP)

(72) Inventor: Makoto FUJINAMI, Tokyo (JP)

(73) Assignee: NEC CORPORATION, Tokyo (JP)

(21) Appl. No.: 15/546,333

(22) PCT Filed: Feb. 3, 2016
(86) PCT No.: PCT/JP2016/000568

§ 371 Date: Jul. 26, 2017

(30) Foreign Application Priority Data
Feb. 4, 2015 (JP) 2015-019887

(51) Int. Cl. H04W 8/24; H04W 48/18; H04W 88/10; H04W 4/00

(52) U.S. Cl. CPC H04W 8/245; H04W 4/005; H04W 48/18; H04W 88/10

(57) ABSTRACT

To provide a new traffic off-load feature according to a terminal type, a communication apparatus of the present invention is provided with a first means for identifying, on the basis of an attribute of the terminal, a network to be connected to the terminal from among a plurality of networks including a first network managed by a first operator and a second network managed by a second operator, and a second means for processing communication with the terminal so that a network node that performs predetermined signal processing in the identified network is connected with the terminal, and is characterized in that the first means can identify the second network managed by the second operator, the second network providing communication service to the subscriber terminal of the second operator by using the network node provided by the first operator.

### TECHNICAL FIELD

The present invention relates to a communication apparatus, a communication system, a communication method, and a recording medium recording a program.

### BACKGROUND ART

In recent years, with popularization of smartphones, smart devices, and the like, communication traffic is rapidly increasing. Further, in the future, it is supposed that M2M (Machine to Machine) communication will increase, and there is a possibility that communication traffic further increases.

To reduce congestion of a network due to a rapid increase in communication traffic, a technique for offloading communication traffic is being studied.

PTL 1, for example, discloses a technique for offloading communication traffic by switching a plurality of types of wireless systems (for example, cellular communication and a wireless LAN (Local Area Network)) based on a congestion state of a network. In PTL 1, for example, traffic of cellular communication is switched to a wireless LAN network, and thereby the traffic is offloaded.

PTL 2 discloses a technique for sharing common wireless access network resources among subscriber units of a plurality of operators. PTL 3 describes that a wireless access network determines a core network operator of a terminal, based on a PLMD identifier included in an initial direct transmission message, and accurately performs routing of an NAS message. PLMD is an abbreviation of Public Land Mobile Network, and NAS is an abbreviation of Non Access Stratum. PTL 4 describes that a server identifies a home agent or a host corresponding to a wireless terminal and supplies an address of the identified home agent or host to a corresponding base station.

### CITATION LIST

### Patent Literature

[PTL 1] Japanese Laid-open Patent Publication No. 2009-118356

[PTL 2] Japanese Translation of PCT International Application Publication No. 2005-539462

[PTL 3] Japanese Laid-open Patent Publication No. 2006-174447

[PTL 4] Japanese Translation of PCT International Application Publication No. 2009-533980

### SUMMARY OF INVENTION

### Technical Problem

In PTL 1, communication traffic paths are switched between different wireless systems, and thereby communication traffic is offloaded.

However, depending on, for example, an attribute/type of a terminal, it may be difficult for the terminal to access a plurality of types of wireless systems. In such a case, it is difficult to offload communication traffic by using the technique in PTL 1. Further, any one of PTLs 2 to 4 does not disclose a means for solving an issue in that, depending on an attribute/type of a terminal, it is difficult for the terminal to access a plurality of types of wireless systems.

An object of the present invention is to provide a new traffic offload technique based on a terminal type.

### Solution to Problem

A communication apparatus according to the present invention includes: a first means for identifying, based on an attribute of a terminal, a to be connected to the terminal among a plurality of networks including a first network managed by a first operator and a second network managed by a second operator; and a second means for processing communication with the terminal in such a way that a network node that executes predetermined signal processing in the identified network and the terminal are connected to each other, wherein the first means can identify, for a subscriber terminal of the second operator, the second network managed by the second operator that provides a communication service by using the network node provided by the first operator.

A communication system according to the present invention includes: a terminal connectable to a network; and a communication apparatus including a first means for identifying, based on an attribute of the terminal, a network to be connected to the terminal among a plurality of networks including a first network managed by a first operator and a second network managed by a second operator, and a second means for processing communication with the terminal in such a way that a network node that executes predetermined signal processing in the identified network and the terminal are connected to each other, wherein the first means can identify, for a subscriber terminal of the second operator, the second network managed by the second operator that provides a communication service by using a wireless band provided by the first operator.

A communication method according to the present invention includes: a first step of identifying, based on an attribute of a terminal, a network to be connected to the terminal among a plurality of networks including a first network managed by a first operator and a second network managed by a second operator; and a second step of processing communication with the terminal in a such a way that a network node that executes predetermined signal processing in the identified network and the terminal are connected to each other, wherein in the first step, for a subscriber terminal of the second operator, the second network managed by the second operator that provides a communication service by using the network node provided by the first operator is identified.

A program according to the present invention causes a computer to execute: a process of identifying, based on an attribute of a terminal, a network to be connected to the terminal among a plurality of networks including a first network managed by a first operator and a second network managed by a second operator; a process of processing communication with the terminal in such a way that a network node that executes predetermined signal processing in the identified network and the terminal are connected to each other; and a process of identifying, for a subscriber terminal of the second operator, the second network managed by the second operator that provides a communication service by using the network node provided by the first operator.

### Advantageous Effects of Invention

According to the present invention, a new traffic offload technique based on a terminal type is provided.

### BRIEF DESCRIPTION OF DRAWINGS

FIG. 1 is a configuration example of a communication system of a first example embodiment.

FIG. 2 is a configuration example of a base station 2 of the first example embodiment.

FIG. 3 is a configuration example of a terminal 1 of the first example embodiment.

FIG. 4 is a sequence diagram illustrating an operation example of the first example embodiment.

FIG. 5 is another configuration example of the communication system of the first example embodiment.

FIG. 6 is a configuration example of an HSS (Home Subscriber Server) of the first example embodiment.

FIG. 7 is a configuration example of a communication system in a second example embodiment.

FIG. 8 is a diagram illustrating a configuration example of a communication apparatus in the second example embodiment.

FIG. 9 is a sequence diagram illustrating an operation example of the second example embodiment.

FIG. 10 is a sequence diagram illustrating another operation example of the second example embodiment.

FIG. 11 is a sequence diagram illustrating another operation example of the second example embodiment.

FIG. 12 is a sequence diagram illustrating another operation example of the second example embodiment.

FIG. 13 is a configuration example of an MME (Mobility Management Entity) of the second example embodiment.

FIG. 14 is another configuration example of the communication system in the second example embodiment.

FIG. 15 is a configuration example of a communication system in a third example embodiment.

FIG. 16 is a configuration example of an RRH of the third example embodiment.

FIG. 17 is a configuration example of a BBU of the third example embodiment.

FIG. 18 is a configuration example of a communication system in a fourth example embodiment.

FIG. 19 is a configuration example of a communication system of a configuration example 1 in the fourth example embodiment.

FIG. 20 is a configuration example of a communication system of a configuration example 2 in the fourth example embodiment.

FIG. 21 is a configuration example of a communication system of a configuration example 3 in the fourth example embodiment.

### DESCRIPTION OF EMBODIMENTS

Example embodiments and configuration examples of the present invention will be described with reference to the accompanying drawings. The example embodiments and the configuration examples are illustrative purpose only, and the present invention is not limited to the example embodiments and the configuration examples. A drawing reference sign appended in this specification is appended to each component as a matter of convenience as an example for assisting understanding, and the description of this summary is not intended for any limitation. Further, in each drawing, an arrow indicating a direction of a signal is illustrative of a direction of a signal in description and does not limit the direction of the signal.

### First Example Embodiment

A first example embodiment of the present invention will be described with reference to corresponding drawings.

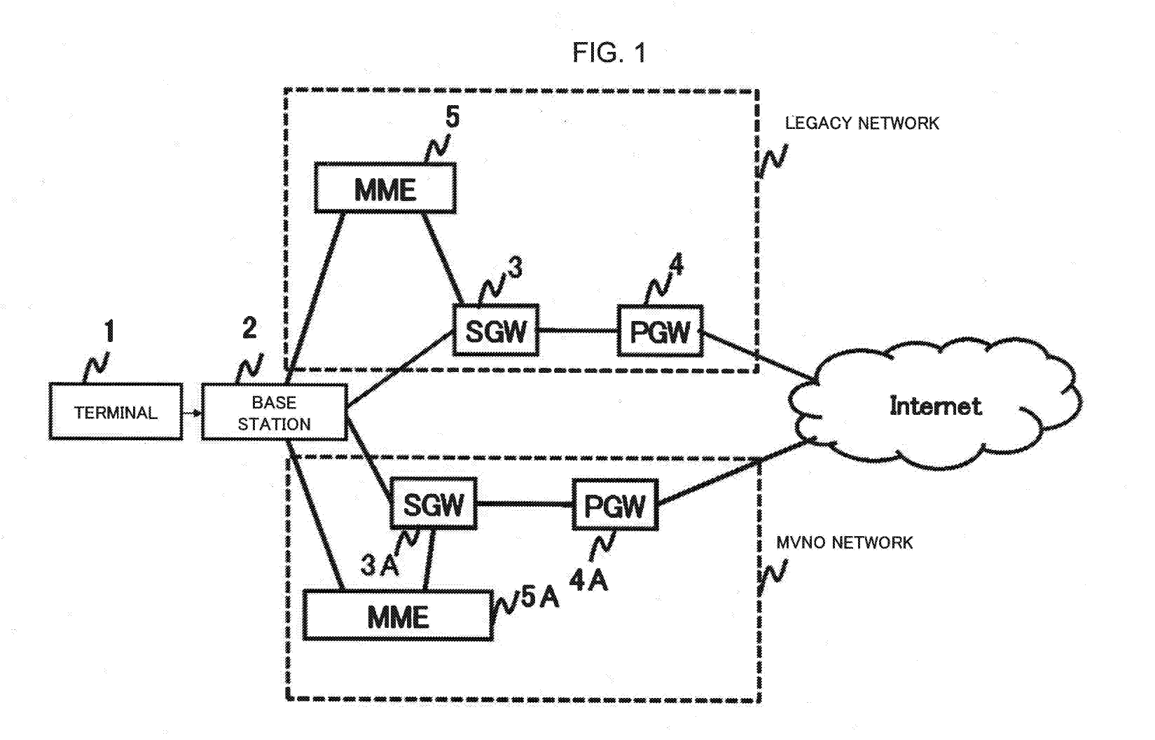

FIG. 1 is a configuration example of a communication system of the first example embodiment. FIG. 1 exemplarily illustrates a communication system of LTE (Long Term Evolution), but the communication system of the present invention is not limited to the example of FIG. 1. The present invention is also applicable, for example, to GPRS (General Packet Radio Service), UMTS (Universal Mobile Telecommunication System), WiMAX (Worldwide Interoperability for Microwave Access), and the like.

In FIG. 1, the communication system of the first example embodiment includes a terminal 1 such as a mobile phone, a PC (Personal Computer), a mobile router, a smart device (for example, a smart meter that monitors home power consumption, a smart television, or a wearable terminal), and an M2M (Machine to Machine) device, and the like. The M2M device includes, in addition to the device described above, for example, industrial equipment, automobiles, healthcare equipment, and home appliances.

The communication system of the first example embodiment includes a legacy network and an MVNO (Mobile Virtual Network Operator) network. The legacy network and the MVNO network are a backbone network such as EPC (Evolved Packet Core) and the like. The legacy network and the MVNO network are a backbone network in which the terminal 1 communicates with an external network such as the Internet and the like via a base station 2.

While the communication system exemplarily illustrated in FIG. 1 includes one legacy network, the number of legacy networks included in a communication network is not limited to one and a plurality of legacy networks may be included. Further, while the communication system exemplarily illustrated in FIG. 1 includes one MVNO network, the number of MVNO networks included in the communication network is not limited to one and a plurality of MVNO networks may be included. The legacy network is managed, for example, by an MNO (Mobile Network Operator) that manages a communication network. The MVNO network is managed, for example, by a Mobile Virtual Network Operator (MVNO).

The MNO is, for example, a network operator that is licensed to use a wireless band (frequency) for wireless communication between the terminal 1 and the base station 2. The MVNO is, for example, a network operator that is not licensed for a wireless band (frequency) used in wireless communication between the terminal 1 and the base station 2.

The MNO rents, for example, a part or the whole of a communication network managed by the MNO to the MVNO. The MNO rents, for example, a network node for providing communication services to the MVNO. The network node is, for example, a base station (eNB) 2, an SGW (Serving Gateway) 3, a PGW (Packet data network Gateway) 4, or an MME (Mobility Management Entity) 5. The MNO rents, for example, a wireless band (frequency) for which a license is granted to the MNO to the MVNO.

The MVNO provides communication services, for example, using a wireless band (frequency) for which a license is granted to the MNO, namely, a licensed band. The MVNO borrows a part or the whole of the licensed band managed by the MNO and provides communication services. A subscriber terminal of the MVNO performs wireless communication with the base station 2, for example, using the licensed band borrowed from the MNO. The subscriber terminal of the MVNO may perform wireless communication with the base station 2 using a frequency band of an unlicensed band.

The MVNO provides communication services, for example, using a network node managed by the MNO, to a subscriber terminal of the MVNO. The MVNO borrows, for example, a part or the whole of a network node managed by the MNO and provides communication services.

The legacy network includes a plurality of network nodes (for example, the base station (eNB) 2, the SGW 3, the PGW 4, and the MME 5) for providing communication services to the terminal 1. Each network node is, for example, a communication apparatus including a predetermined communication function.

The terminal 1, for example, is connected to the base station 2 and accesses a network such as the Internet and the like via the SGW 3 and the PGW 4.

The communication system of FIG. 1 may include, other than the legacy network and the MVNO network, another network. Further, the legacy network and the MVNO network each may include a plurality of types of networks. The legacy network and the MVNO network each may include a plurality of types of networks such as an LTE network, a GPRS network, a UMTS network, and the like, for example.

Each network node exemplarily illustrated in FIG. 1 executes predetermined signal processing. Each network node includes, for example, the following functions for signal processing.

PGW 4:

A function (User-Plane function) for processing a packet
A PCEF (Policy and Charging Enforcement Function) for managing a charging state according to communication
A PCRF (Policy and Charging Rule Function) for controlling a policy such as QoS (Quality of Service) and the like

SGW 3:

A function (User-Plane function) for processing a packet
A function (C-Plane function) for processing control signaling
An LI (Lawful Interception) function

MME 5:

A function (C-Plane function) for processing control signaling
A function of managing subscriber information of a communication system in conjunction with an HSS (Home Subscriber Server)

The MVNO network includes a plurality of network nodes (for example, an SGW 3A, a PGW 4A, and an MME 5A) for providing communication services to the terminal 1. Functions of each network node (for example, the SGW 3A, the PGW 4A, or the MME 5A) included in the MVNO network are similar to the functions of each network node (for example, the SGW 3, the PGW 4, or the MME 5) included in the legacy network, and therefore detailed description will be omitted.

In the communication system exemplarily illustrate in FIG. 1, the base station 2 is managed by an MNO that manages the legacy network. In the first example embodiment, the base station 2 distributes communication traffic between the legacy network and the MVNO network. In other words, the communication traffic is distributed to a plurality of networks (for example, the legacy network and the MVNO network) that constitute a backbone of a wireless network between the terminal 1 and the base station 2. In other words, even when, for example, it is difficult for the terminal 1 to access a wireless network such as a wireless LAN and the like, communication traffic is offloaded in a backbone network. Therefore, the base station 2 can perform a new traffic offload according to a terminal type.

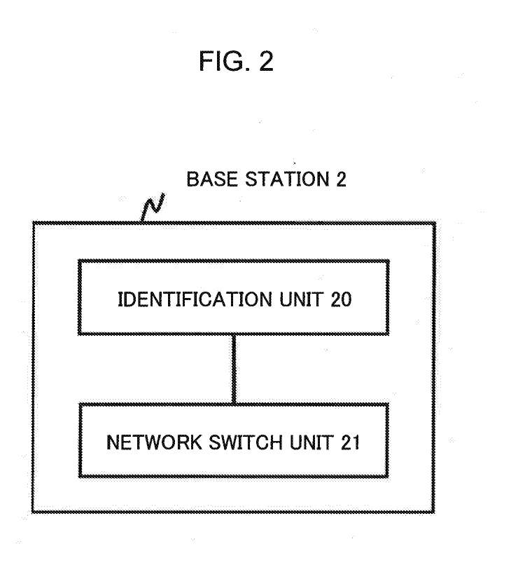

FIG. 2 illustrates a configuration example of the base station 2. The base station 2 includes an identification unit 20 and a network switch unit 21.

The identification unit 20 identifies a network to be connected to the terminal 1. The identification unit 20 identifies a network to be connected to the terminal 1 from a network node of a legacy network and a plurality of networks including an MVNO network. Further, the identification unit 20 may identify a network node included in a network to be connected to the terminal 1. The identification unit 20 may identify a type of communication traffic and an attribute/type of the terminal 1. In this case, the identification unit 20 selects a network corresponding to communication traffic of the identified type and the terminal 1 from a plurality of networks including the legacy network and the MVNO network. The identification unit 20 may select a network node corresponding to the identified communication traffic and the terminal 1 from a plurality of network nodes including a network node of the legacy network and a network node of the MVNO network.

The identification unit 20 can identify an attribute of communication traffic and an attribute of the terminal 1, for example, based on predetermined information. The identification unit 20 identifies communication traffic to be processed in the MVNO network, for example, based on predetermined information. The identification unit 20 may identify whether the terminal 1 is a terminal 1 having an attribute to be processed in the MVNO network, for example, based on predetermined information.

The identification unit 20 may identify that the terminal 1 is, for example, a terminal corresponding to a predetermined network. The identification unit 20 identifies that the terminal 1 is, for example, a terminal corresponding to an MVNO network. Further, the identification unit 20 may identify that the terminal 1 is, for example, a terminal corresponding to a predetermined MNO. In this case, the identification unit 20 identifies that the terminal 1 is a terminal corresponding to an MVNO. Further, the identification unit 20 may identify that the terminal 1 is, for example, a terminal subscribing to a predetermined MNO. The identification unit 20 may identify that the terminal 1 is, for example, a terminal subscribing to an MVNO.

The identification unit 20 may select, when, for example, a communication system includes a plurality of MVNO networks, an MVNO network to be connected to the terminal 1 among the plurality of MVNO networks based on predetermined information.

The identification unit 20 can identify, for example, based on predetermined information included in a connection request from the terminal 1, a network corresponding to the terminal 1 or communication traffic of the terminal 1. The identification unit 20 identifies, for example, based on information that can identify a network to be connected to the terminal 1, a network corresponding to the terminal 1 or communication traffic of the terminal 1.

The identification unit 20 identifies, for example, based on information indicating that the terminal 1 is a terminal corresponding to an MVNO network, a network corresponding to the terminal 1 or communication traffic of the terminal 1 as the MVNO. The identification unit 20 may identify, for example, based on information identifying an MVNO (or an MNO) to which the terminal 1 subscribes, a network corresponding to the terminal 1 or communication traffic of the terminal 1 as the MVNO (or the MNO). The identification unit 20 may identify, for example, based on information indicating that the terminal 1 is subscribing to an MVNO (or an MNO), a network corresponding to the terminal 1 or communication traffic of the terminal 1 as the MVNO (or the MNO).

The identification unit 20 can identify, for example, based on a PLMN ID (Public Land Mobile Network Identifier) included in a connection request from the terminal 1, a network corresponding to the terminal 1 or communication traffic of the terminal 1. The PLMN ID is a network identification number of a mobile network operator (or a mobile virtual network operator) or a communication network (a legacy network or an MVNO network), and is allocated, for example, for each MNO (MVNO) or each communication network.

The PLMN ID is included, for example, in an “RRC Connection Setup Request” from the terminal 1. The PLMN ID is included, for example, in an “RRC Connection Setup Complete” from the terminal 1. The identification unit 20 can identify, for example, based on a PLMN ID included in an “RRC Connection Setup Complete” from the terminal 1, a network corresponding to the terminal 1 or communication traffic of the terminal 1.

The network switch unit 21 switches a network to be connected to the terminal 1 based on an identification result of the identification unit 20. The network switch unit 21 switches a transfer path of communication traffic, for example, in such a way as to pass through a network (for example, a legacy network or an MVNO network) in which communication traffic for the terminal 1 has been identified. The network switch unit 21 transfers, to a network identified to correspond to the terminal 1, communication traffic of the terminal 1. The network switch unit 21 transfers, for example, communication traffic of a specific terminal 1, which is identified by the identification unit 20 to correspond to an MVNO network, to the MVNO network.

The network switch unit 21 manages, for example, network nodes (for example, the SGW 3, the PGW 4, and the MME 5) of a legacy network and network nodes (for example, the SGW 3A, the PGW 4A, and the MME 5A) of an MVNO network separately. The network switch unit 21 manages, for example, identification information (for example, addresses of network nodes) relating to network nodes of a legacy network and identification information relating to network nodes of an MVNO network separately. Further, the network switch unit 21 may associate, for example, identification information of each network node with a flag indicating whether the network node is a network node included in an MVNO network (or a legacy network). The network switch unit 21 can transmit, for example, communication traffic to be transferred to an MVNO network to the network nodes on the MVNO network.

The network switch unit 21 transfers communication traffic of the terminal 1, for example, to an identified communication network. The network switch unit 21 may transfer communication traffic of the terminal 1, for example, to a predetermined communication network based on an identification result of the identification unit 20. The network switch unit 21 transfers communication traffic of the terminal 1, for example, to a legacy network managed by an identified MNO. The network switch unit 21 may transfer communication traffic of the terminal 1, for example, to a network managed by a predetermined MNO based on an identification result of the identification unit 20.

The identification unit 20 may identify the terminal 1 corresponding to a predetermined network, for example, based on a PLMN ID. The network switch unit 21 transfers communication traffic of the terminal 1, for example, to a predetermined network identified. The identification unit 20 identifies the terminal 1 corresponding to an MVNO network (or a legacy network), for example, based on a PLMN ID. The network switch unit 21 transfers, for example, traffic of the terminal 1 identified to correspond to an MVNO network to the MVNO network.

The identification unit 20 may identify, for example, a predetermined network (a legacy network or an MVNO network) corresponding to the terminal 1. In this case, the network switch unit 21 transfers communication traffic from the terminal 1, for example, to a predetermined network (a legacy network or an MVNO network) identified.

In FIG. 2, an example in which the base station 2 includes functions of the identification unit 20 and the network switch unit 21 is described. However, the MME 5 may include the functions of the identification unit 20 and the network switch unit 21. The MME 5 may identify, for example, an attribute/type of a terminal based on an IMSI (International Mobile Subscriber Identity). The IMSI refers to identification information of a terminal.

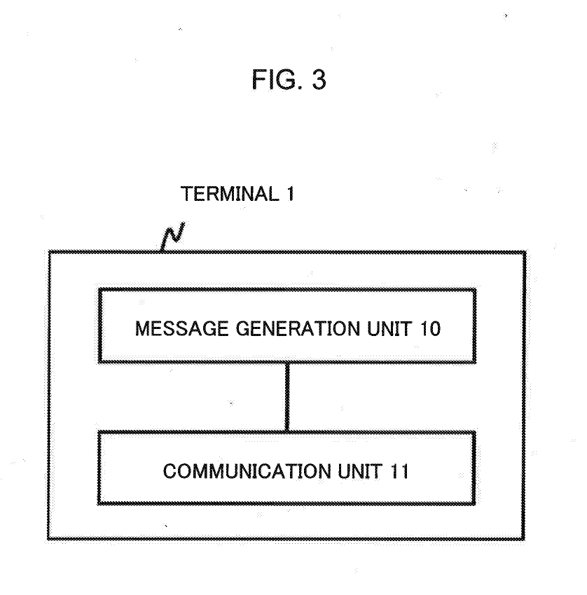

FIG. 3 illustrates a configuration example of the terminal 1 of the first example embodiment. As exemplarily illustrated in FIG. 3, the terminal 1 includes a message generation unit 10 and a communication unit 11.

The message generation unit 10 generates a message for selecting a network by the base station 2. The message generation unit 10 generates, for example, a message including information that can identify a network to be connected to the terminal 1. The message generation unit 10 generates, for example, a message including information indicating that the terminal 1 is a terminal corresponding to an MVNO network (or a legacy network). The message generation unit 10 generates, for example, a message including information that identifies a predetermined MNO (or MVNO) to which the terminal 1 subscribes. The message generation unit 10 generates, for example, a message including information indicating that the terminal 1 is subscribing to an MNO (or an MVNO).

The communication unit 11 transmits a generated message to the base station 2.

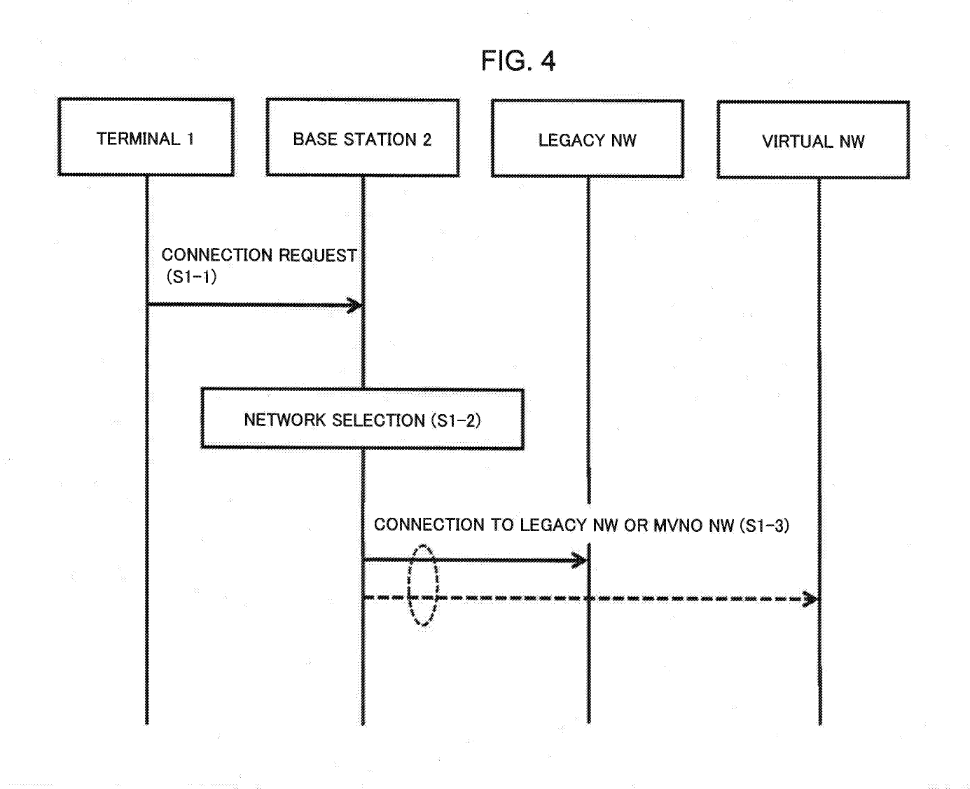

FIG. 4 is a sequence diagram illustrating an operation example of the first example embodiment.

The terminal 1 notifies the base station 2 of a connection request to a network (S1-1). The terminal 1 notifies the base station 2 of a connection request to a network when, for example, its power has been turned on or its cellular communication function has been turned on.

The base station 2 selects a network to be connected to the terminal 1 in response to the connection request from the terminal 1 (S1-2). The base station 2 selects a network corresponding to the terminal 1, for example, from a plurality of networks including a legacy network or an MVNO network. The base station 2, for example, identifies a network corresponding to the terminal 1 and selects the identified network as a network to be connected to the terminal 1. The base station 2 selects, for example, an MVNO network for the terminal 1 based on a fact that the terminal 1 having made a notification of a connection request is a terminal subscribing to an MVNO.

The base station 2 connects the terminal 1 to the selected network (S1-3). The base station 2 connects the terminal 1 to a network corresponding to the terminal 1 from a plurality of networks including a legacy network and an MVNO network.

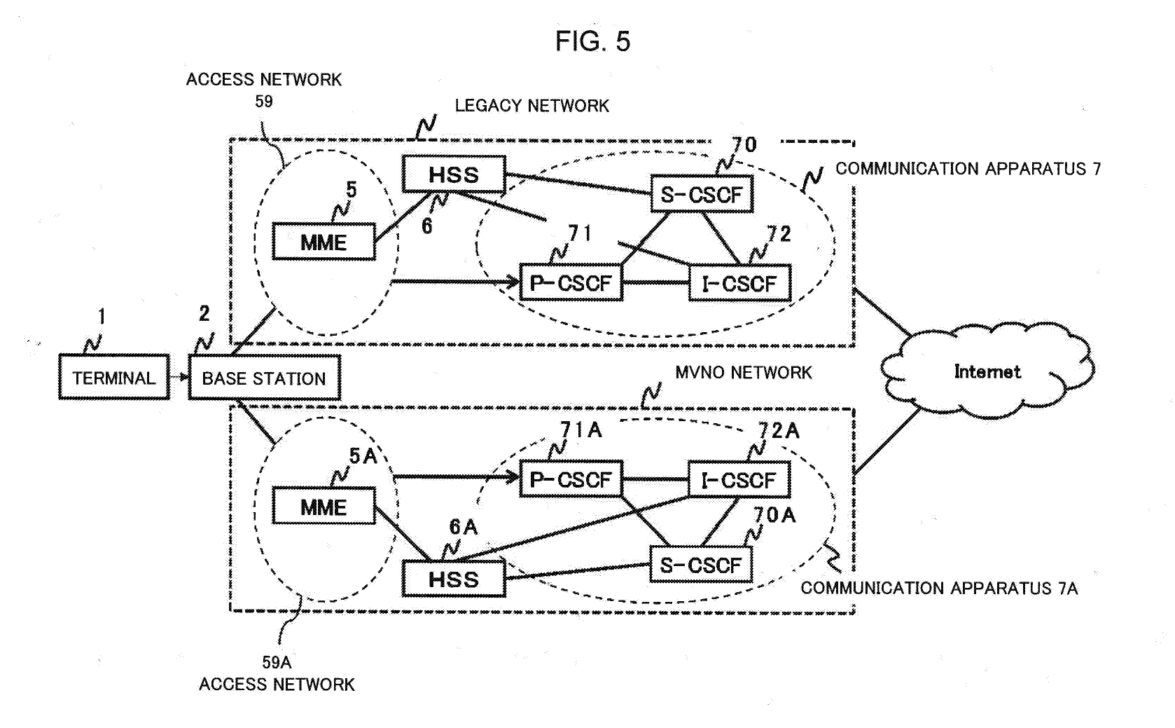

FIG. 5 is another configuration example of the communication system of the first example embodiment. A communication system exemplarily illustrated in FIG. 5 includes, for example, a terminal 1, a base station 2, a legacy network, and an MVNO network.

The legacy network includes, for example, an access network 59, an HSS 6, and a communication apparatus 7.

The access network 59 includes an MME 5. The MME 5 processes control signaling in conjunction with the HSS 6 that manages subscriber information of the communication system.

The HSS 6 manages subscriber information of the communication system. The HSS 6 stores, for example, information relating to subscribers of the communication system and executes authentication and authorization for a user of the terminal 1. The HSS 6 provides, for example, location information and IP (Internet Protocol) information of the terminal 1 to another apparatus (for example, the MME 5).

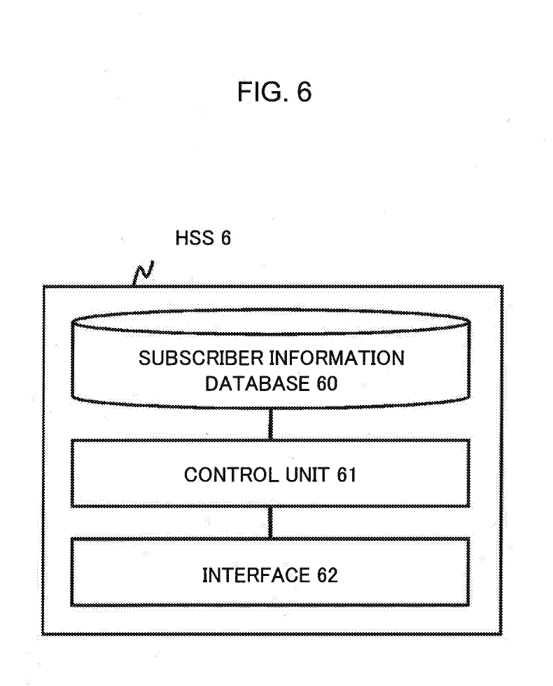

FIG. 6 is a diagram illustrating a configuration example of the HSS 6. As exemplarily illustrated in FIG. 6, the HSS 6 includes a subscriber information database 60, a control unit 61, and an interface 62.

The subscriber information database 60 holds user information/subscriber information of the communication system. The subscriber information database 60 holds, for example, an IMSI used to identify a user and an MSISDN (Mobile Subscriber Integrated Services Digital Network Number) corresponding to a phone number of a user. The subscriber information database 60 holds, for example, an IMPI (IP Multimedia Private Identity) and an IMPU (IP Multimedia Public Identity). The subscriber information database 60 holds, in addition thereto, information relating to users and subscribers.

The subscriber information database 60 manages, for example, an IMSI of a terminal subscribing to a predetermined MNO. The subscriber information database 60 manages, for example, an IMSI of a terminal subscribing to an MNO. The subscriber information database 60 manages, for example, an IMSI of a terminal subscribing to an MVNO. The subscriber information database 60 may manage, for example, for each MNO, an IMSI of a terminal subscribing to the MNO. The subscriber information database 60 may manage, for example, an IMSI of a terminal subscribing to an MNO and an IMSI of a terminal subscribing to an MVNO separately.

The control unit 61 includes a function equivalent to C-Plane. The control unit 61 transmits/receives control signaling via the interface 62. The control unit 61 refers to, for example, the subscriber information database 60 and executes authentication and authorization of a user of the terminal 1. The control unit 61 refers to, for example, the subscriber information database 60 and provides location information and IP information of the terminal 1 to another apparatus (for example, the MME 5). The IP information includes information relating to network connection such as an IP address of the terminal 1

The interface 62 is an interface for communication with the MME 5, the communication apparatus 7, and the like. The HSS 6 can communicate with the MME 5, the communication apparatus 7, and the like using a predetermined protocol via the interface 62. The HSS 6 can communicate with the communication apparatus 7, for example, using a Diameter protocol via the interface 62.

The communication apparatus 7 is a CSCF (Call Session Control Function) that provides a session control function in an IMS (IP (Internet Protocol) Multimedia Subsystem) network. The communication apparatus 7 is, for example, an S-CSCF (Serving-CSCF) 70, a P-CSCF (Proxy-CSCF) 71, or an I-CSCF (Interrogating-CSCF) 72. The S-CSCF 70, the P-CSCF 71, and the I-CSCF 72 each can process an SIP (Session Initiation Protocol) signal.

The S-CSCF 70 executes session control and user authentication using subscriber information (user information) of the communication system obtained from the HSS 6. The S-CSCF 70 includes, for example, a function of receiving a session initiation signal from the terminal 1, selecting an AS (Application Server) in accordance with a service, and relaying an SIP signal to the AP. The S-CSCF 70 includes, for example, a function of executing, when the terminal 1 has designated a communication partner using a phone number, routing based on the phone number.

The S-CSCF 70 relays an SIP signal, for example, for media control of voices and a video, from an AS to an MRFC (MRF Controller) included in an MRF (Media Resource Function) that provides a function for media control.

The S-CSCF 70 transmits/receives, for example, an SIP signal for another network to/from an MGCF (Media Gateway Controller Function) that converts a call control protocol.

The P-CSCF 71 is disposed at a connection point between an IMS network and the access network 59. The P-CSCF 71 is connected to the PGW 4 when, for example, the access network 59 corresponds to LTE (Long term Evolution) and EPC (Evolved Packet Core). The P-CSCF 71 is connected to a GGSN (Gateway GPRS (General Packet Radio Service) Support Node) when, for example, the access network 59 corresponds to W-CDMA (Wideband CDMA (Code Division Multiple Access)). The GGSN includes a function of controlling connection to an external IP (Internet Protocol) network based on a connection request from the terminal 1.

The P-CSCF 71 relays, for example, an SIP signal transmitted/received among the terminal 1, the S-CSCF 70, and the I-CSCF 72. The P-CSCF 71 executes, for example, validation of an SIP signal transmitted from the terminal 1 and adds information (for example, charging information) necessary for session control to the SIP signal for the S-CSCF 70. The P-CSCF 71 notifies, for example, a PCRF (Policy and Charging Enforcement Function) that provides a function of performing a policy and charging of an application type necessary to execute QoS control in IMS.

The I-CSCF 72 relays, for example, an SIP signal transmitted/received between another network and the S-CSCF 70. The I-CSCF 72 selects the S-CSCF 70, for example, at the time of registration for an IMS network or session control based on user information of the HSS 6.

The MVNO network includes, for example, an access network 59A, an HSS 6A, and a communication apparatus 7A. The MME 5A, the HSS 6A, and the communication apparatus 7A included in the access network 59A have the same configurations as those of the MME 5, the HSS 6, and the communication apparatus 7 included in the legacy network, respectively, and therefore detailed description will be omitted.

As described above, the communication system of the first example embodiment can distribute communication traffic between a legacy network and an MVNO network. In other words, communication traffic is distributed to a plurality of networks (for example, a legacy network and an MVNO network) that constitute a backbone of a wireless network between the terminal 1 and the base station 2. In other words, even when, for example, it is difficult for the terminal 1 to access a wireless network such as a wireless LAN and the like, communication traffic is offloaded in a backbone network. Therefore, the communication system of the first example embodiment can execute new traffic offload according to a terminal type.

### Second Example Embodiment

In a second example embodiment of the present invention, at least a part of functions of network nodes included in an MVNO network is operated virtually using software and the like. A technique of the second example embodiment is applicable to any of the first example embodiment and example embodiments to be described later.

In a communication system of the second example embodiment, network nodes included in an MVNO network are virtually operated using software and the like. Therefore, an MNO that manages an MVNO network can construct easily and at low cost network nodes that provide a function of a backbone network such as EPC and the like using software.

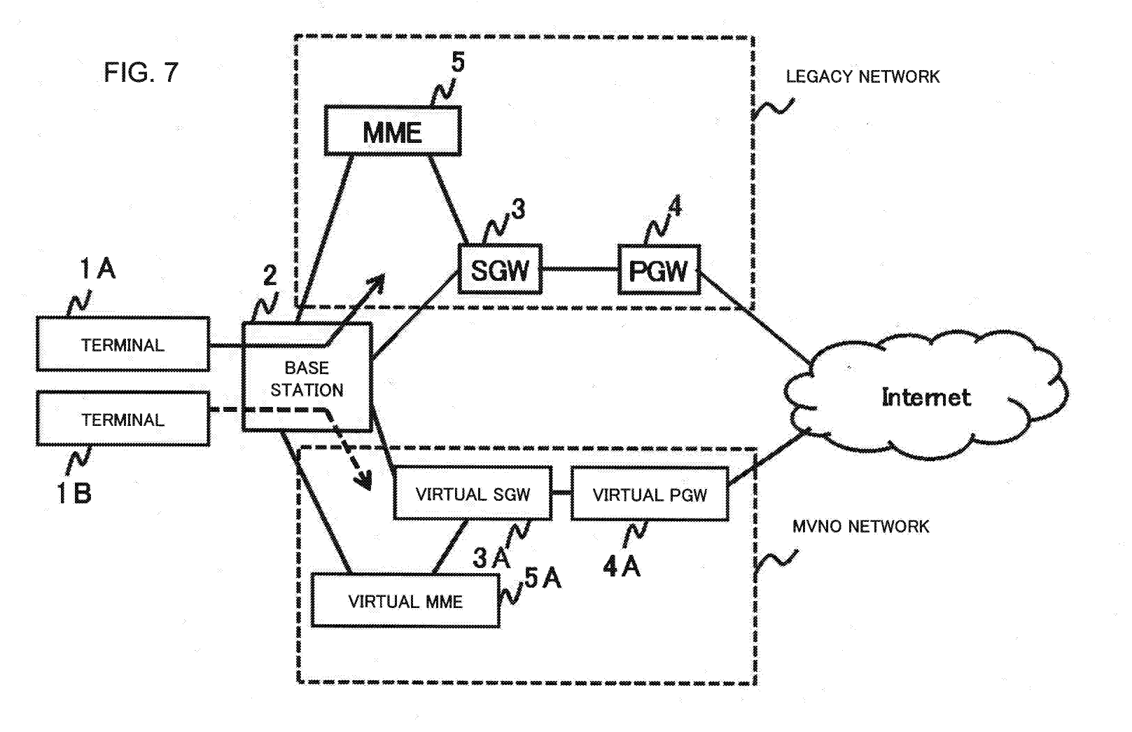

FIG. 7 illustrates a configuration example of the communication system of the second example embodiment of the present invention.

In FIG. 7, a terminal 1A is a terminal corresponding to a legacy network. The terminal 1A is, for example, a terminal subscribing to an MNO that manages a legacy network. A terminal 1B is a terminal corresponding to a MVNO network. The terminal 1B is, for example, a subscriber terminal of an MVNO (a terminal subscribing to an MVNO). A configuration example of the terminal 1A and the terminal 1B exemplarily illustrated in FIG. 7 is the same as the configuration example of the terminal 1 of the first example embodiment, and therefore detailed description will be omitted.

The terminal 1B may be, for example, an MTC (Machine Type Communication) device. The MTC device is, for example, a smart device (a smart meter that monitors home power consumption, a smart television, or a wearable terminal), industrial equipment, an automobile, healthcare equipment, a home appliance, medical equipment, a biological implant, or the like. The MTC means a mode of data communication in which human intervention is not always necessary as in, for example, a smart meter. In other words, the MTC device can autonomously communicate with a device of a communication partner. Standardization of MTC is in progress in 3GPP (3rd Generation Partnership Project) TS22.368 and the like. It is supposed that the MTC device communicates at a specific time (for example, “PM 12:00 every day” or “AM 3:00 every Friday”). In this case, it is supposed that a large number of MTC devices of the same type (for example, smart meters) start communicating at the same time and a large amount of traffic is generated at a specific time. Such a large amount of traffic causes a large load on a legacy network. Therefore, when such a large amount of traffic is processed, for example, by an MVNO network, the load on the legacy network can be reduced.

In the communication system exemplarily illustrated in FIG. 7, the base station 2 is managed by an MNO that manages a legacy network. As exemplarily illustrated in FIG. 7, the base station 2 can connect the terminal 1A to a legacy network. Further, the base station 2 can connect the terminal 1B to an MVNO network. A configuration example of the base station 2 exemplarily illustrated in FIG. 7 is the same as the configuration example of the base station 2 of the first example embodiment, and therefore detailed description will be omitted.

In a second communication system, the terminal 1B that is a subscriber terminal of an MVNO may use a frequency band of an unlicensed band and perform wireless communication with the base station 2.

As exemplarily illustrated in FIG. 7, the legacy network includes a plurality of network nodes (for example, an SGW 3, a PGW 4, and an MME 5). Functions of the network nodes (the SGW 3, the PGW 4, and the MME 5) exemplarily illustrated in FIG. 7 are similar to the functions described in the first example embodiment, and therefore detailed description will be omitted.

As exemplarily illustrated in FIG. 7, in the MVNO network, at least a part of the functions of the network nodes is virtually operated by software. A function of a network node is operated, for example, by an application on a virtual machine. A virtual network is constructed, for example, in a data center including a server and a communication device (a router or the like). In the virtual network, a function of a network node (for example, a function of an MME) may be operated by software such as a virtual machine and the like.

An MVNO network is constructed, for example, by a dynamic scale-out/scale-in operation of a virtual machine. An operator of an MVNO network can construct, for example, depending on a situation of communication traffic in the MVNO network, an MVNO network by dynamically starting a virtual machine. Further, an operator of an MVNO network can also construct an MVNO network, for example, by dynamically starting a virtual machine in a predetermined time zone. An operator of an MVNO network can dynamically construct an MVNO network by starting a virtual machine corresponding to predetermined communication traffic or communication traffic of the terminal 1B. An operator of an MVNO network can dynamically construct an MVNO network by starting a virtual machine in such a way as to satisfy a request condition (for example, an SLA: a Service Level Agreement) for processing of communication traffic.

An operator of an MVNO network can reduce resources allocated to the MVNO network and suppress power consumption of a data center, for example, by stopping a virtual machine in a predetermined time zone having a small amount of communication traffic.

In the second example embodiment, the MVNO network includes, for example, a virtual network node operated by a virtual machine dynamically constructed based on a request condition for processing of communication data of the terminal 1B. The request condition is, for example, a performance or communication band necessary for processing of communication data of the terminal 1B, an SLA necessary for communication of the terminal 1B that is an MTC device, or a time zone in which communication by the terminal 1B is generated, or the like.

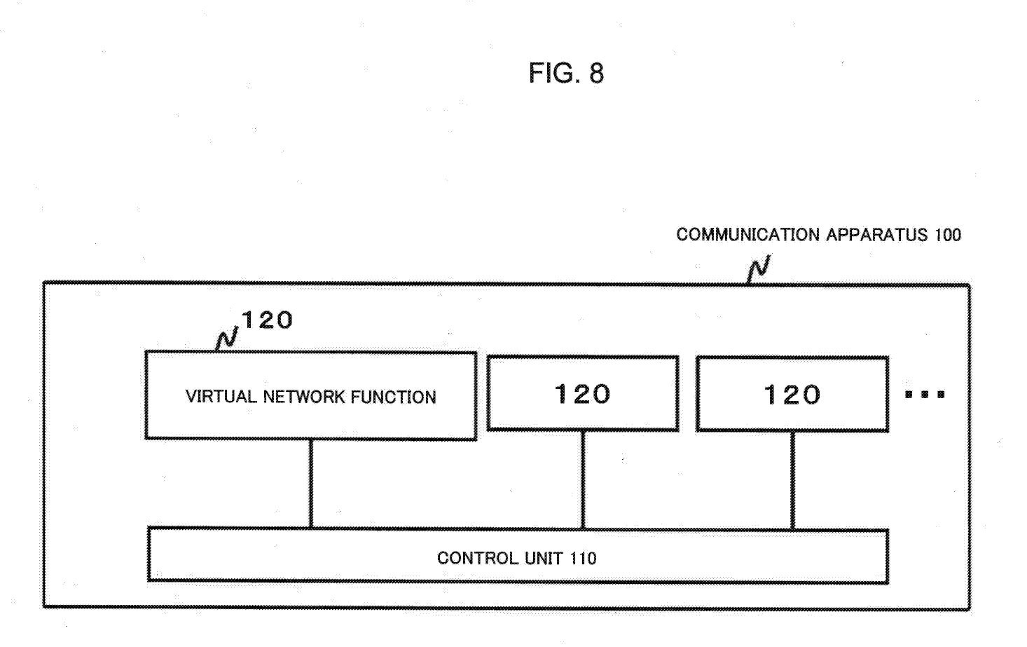

FIG. 8 illustrates a configuration example of a communication apparatus 100 of the second example embodiment. The communication apparatus 100 is, for example, a server, a switch, or a router. The communication apparatus 100 operates a virtual machine that provides a function of a virtual network node (for example, a virtual SGW 3A, a virtual PGW 4A, or a virtual MME 5A) in a virtual network.

The communication apparatus 100 includes a control unit 110 and a VNF (Virtual Network Function) 120.

The control unit 110 can operate, on a virtual machine, the VNF 120 that provides a function of a virtual network node. The control unit 110 may include control software such as Hypervisor and the like that can execute virtualization of a computer, for example.

The control unit 110 can execute at least one of a start, a stop, or a migration (a virtual machine is migrated to another communication apparatus 100) of a virtual machine that operates the VNF 120.

Each virtual network node includes, for example, the following functions.

Virtual PGW 4A:

A function (User-Plane function) for processing a packet
A PCEF (Policy and Charging Enforcement Function) for managing a charging state according to communication
A PCRF (Policy and Charging Rule Function) for controlling a policy such as QoS and the like

Virtual SGW 3A:

A function (User-Plane function) for processing a packet
A function (C-Plane function) for processing control signaling
An LI (Lawful Interception) function

Virtual MME 5A:

A function (C-Plane function) for processing control signaling
A function of managing subscriber information of a communication system in conjunction with an HSS (Home Subscriber Server)

The VNF 120 operates as the above-described virtual network node on a virtual machine. In the above-described example embodiment, the VNF 120 is constructed for each virtual network node, but the VNF 120 may be constructed for each function included in each virtual network node. The VNF 120 may operate, for example, as a U-Plane function of the virtual PGW 4A on a virtual machine.

In the example of FIG. 7, a network node included in a legacy network may be virtually operated by software and the like. In this case, a legacy network and an MVNO network may be constructed, for example, in the same data center. When a legacy network and an MVNO network are constructed in the same data center, the legacy network and the MVNO network are constructed separately. A legacy network and an MVNO network are constructed separately, for example, in a data center that can construct a multi-tenant as different tenants.

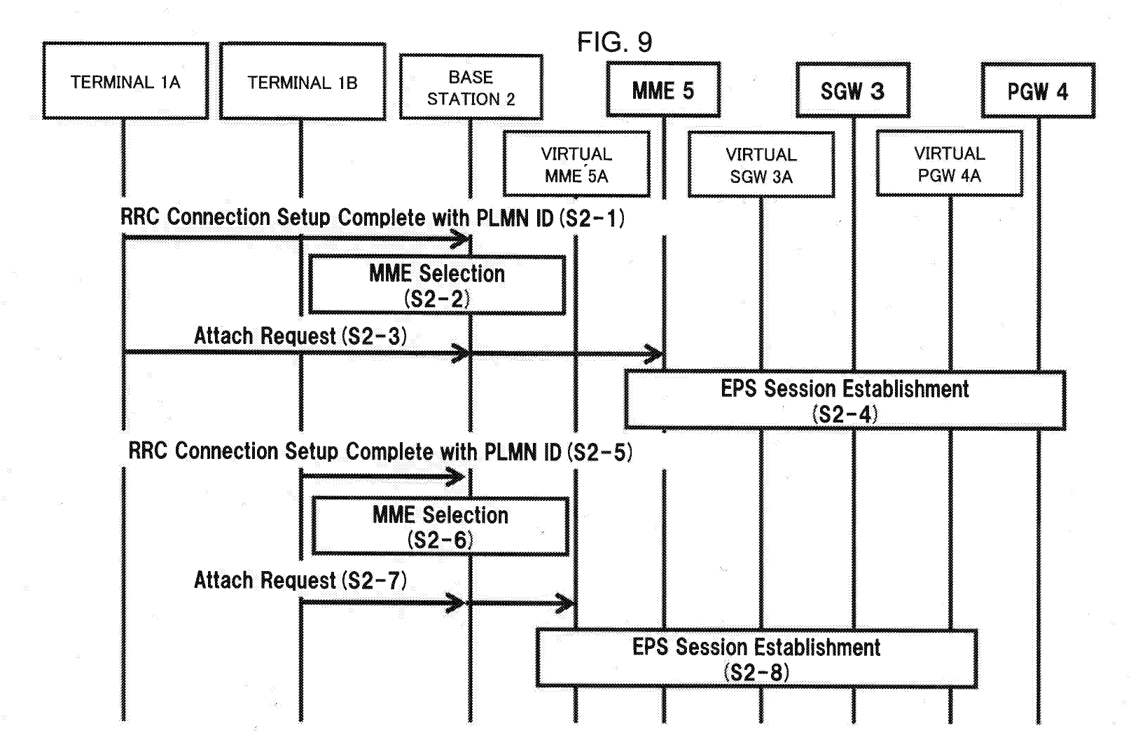

FIG. 9 illustrates an operation example of the second example embodiment. FIG. 9 illustrates an operation example in which the technique of the present example embodiment is applied to “Attach Procedure” described in chapter 5.3.2 of a specification (TS23.401 v12.3.0) of 3GPP.

The terminal 1A transmits a “RRC Connection Setup Complete” including a PLMN ID (described as “RRC Connection Setup Complete with PLMN ID” in S2-1 of FIG. 9) to the base station 2 as a response to a “RRC Connection Setup” from the base station 2.

The base station 2 selects an MME to be connected to the terminal 1A in response to reception of the “RRC Connection Setup Complete” (S2-2). The identification unit 20 of the base station 2 may identify a network corresponding to the terminal 1A, for example, based on information included in the “RRC Connection Setup Complete.”

The identification unit 20 identifies a network corresponding to the terminal 1A, for example, based on the PLMN ID included in the “RRC Connection Setup Complete” and selects an MME included in the network identified for the terminal 1A. The PLMN ID included in the “RRC Connection Setup Complete” transmitted from the terminal 1A indicates a legacy network or a network number of an MNO that manages a legacy network. Therefore, in S2-2, the identification unit 20 identifies that, for example, the terminal 1A is a terminal subscribing to an MNO that manages a legacy network and selects the MME 5 included in the legacy network for the terminal 1A.

The terminal 1A transmits a message (“Attach Request”) for requesting connection to a network to the base station 2. The network switch unit 21 of the base station 2 transmits the “Attach Request” transmitted from the terminal 1A to the MME 5 of the legacy network corresponding to the terminal 1A (S2-3).

In response to reception of the “Attach Request,” the MME 5 of the legacy network starts an establishment procedure of an EPS (Evolved Packet System) bearer (S2-4). By starting the establishment procedure of an EPS bearer by the MME 5, a control signal is exchanged among the SGW 3, the PGW 4, the MME 5, and the base station 2. By the exchange of the control signal among the nodes, an EPS bearer is established. The terminal 1A communicates via the established EPS bearer. The network switch unit 21 of the base station 2 transmits/receives communication data relating to the terminal 1A via the EPS bearer.

The terminal 1B transmits a “RRC Connection Setup Complete” including a PLMN ID (described as “RRC Connection Setup Complete with PLMN” in S2-5 of FIG. 9) to the base station 2.

The base station 2 selects an MME to be connected to the terminal 1B in response to reception of the “RRC Connection Setup Complete” (S2-6). The identification unit 20 of the base station 2 may identify a network corresponding to the terminal 1B, and in this case, may identify an MVNO network as the network corresponding to the terminal 1B.

The PLMN ID included in the “RRC Connection Setup Complete” transmitted from the terminal 1B indicates an MVNO network or a network identification number of an MVNO that manages an MVNO network. Therefore, in S2-5, the identification unit 20 identifies that, for example, the terminal 1B is a terminal subscribing to an MVNO and selects the virtual MME 5A included in the MVNO network for the terminal 1B.

The terminal 1B transmits a message (“Attach Request”) for requesting connection to a network to the base station 2. The network switch unit 21 of the base station 2 transmits the “Attach Request” transmitted from the terminal 1B to the virtual MME 5A of the selected MVNO network (S2-7).

In response to reception of the “Attach Request,” the virtual MME 5A starts an establishment procedure of an EPS bearer (S2-8). By starting the establishment procedure of an EPS bearer by the virtual MME 5A, a control signal is exchanged among the virtual SGW 3A, the virtual PGW 4A, the virtual MME 5A, and the base station 2. By the exchange of the control signal among the nodes, an EPS bearer is established. The terminal 1B communicates via the established EPS bearer. The network switch unit 21 of the base station 2 transmits/receives communication data relating to the terminal 1B via the EPS bearer.

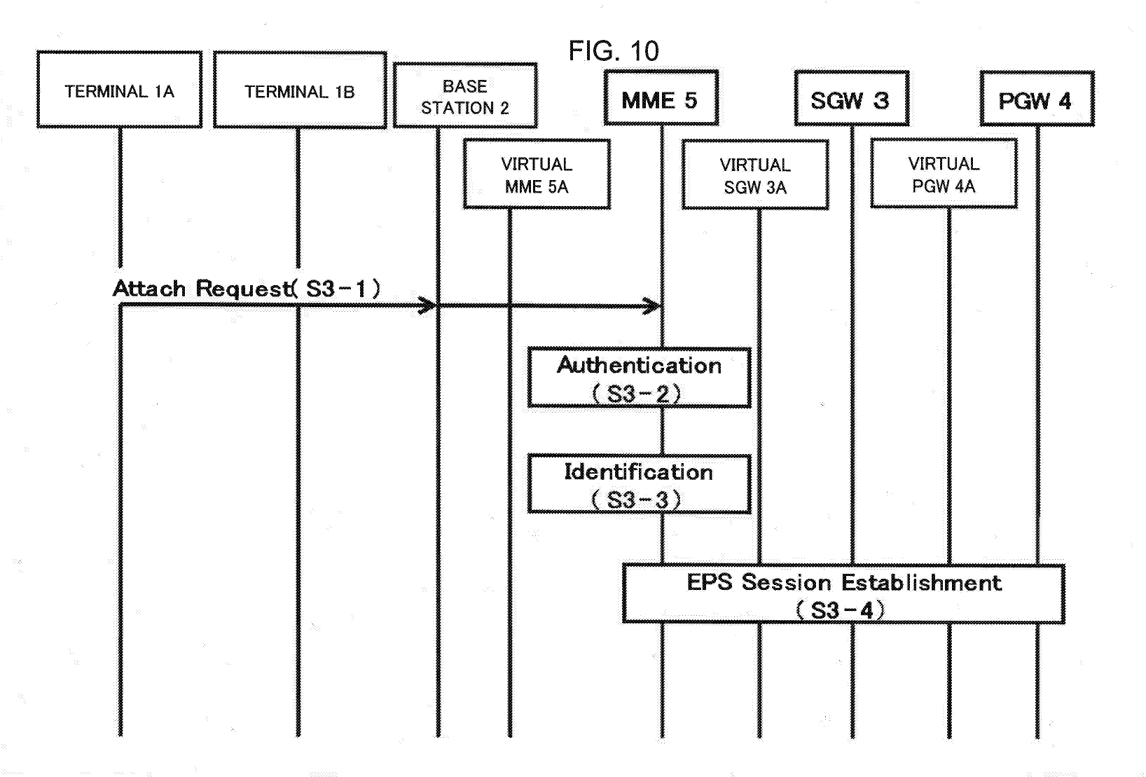

FIG. 10 to FIG. 12 illustrate other operation examples of the second example embodiment. FIG. 10 to FIG. 12 are operation examples in which an attribute/type of the terminal 1 is identified by the MME 5. FIG. 10 to FIG. 12 illustrate operation examples in which the technique of the present example embodiment is applied to “Attach Procedure” described in chapter 5.3.2 of a specification (TS23.401 v12.3.0) of 3GPP.

FIG. 10 illustrates an operation example of the terminal 1A corresponding to a legacy network.

The terminal 1A transmits an “Attach Request” to the base station 2 (S3-1). The base station 2 transmits the “Attach Request” to the MME 5 of the legacy network.

The MME 5 executes an authentication procedure of a terminal in response to reception of the “Attach Request” (S3-2).

The MME 5 executes identification of an attribute/type of a terminal in the authentication procedure (S3-3). The MME 5 identifies an attribute/type of a terminal based on an IMSI (International Mobile Subscriber Identity) included in the “Attach Request.” The IMSI is identification information of the terminal.

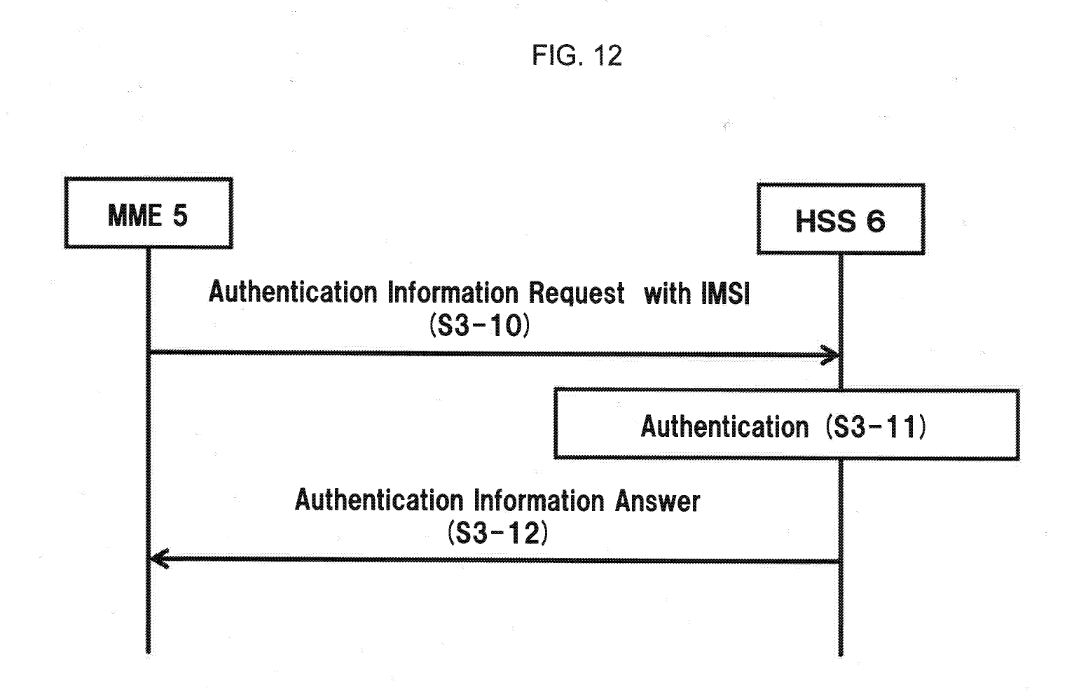

FIG. 12 illustrates an operation example in which the MME 5 identifies a terminal attribute/type in the authentication procedure. In the example of FIG. 12, the HSS 6 executes the authentication procedure in response to an “Authentication Information Request” from the MME 5. The MME 5 may execute the authentication procedure by referring to the HSS 6.

The MME 5 transmits an “Authentication Information Request” to the HSS 6 (S3-10). The “Authentication Information Request” includes an IMSI.

The HSS 6 manages subscriber information of a communication system. The HSS 6 stores, for example, information relating to subscribers of a network and executes authentication of a user of the terminal 1. The HSS 6 provides, for example, location information and IP information of the terminal 1 to another apparatus (for example, the MME 5).

The HSS 6 executes authentication of a user of the terminal 1 based on the IMSI included in the “Authentication Information Request” received from the MME 5 and the stored information relating to subscribers of the network (S3-11).

The HSS 6 executes authentication of a user of the terminal 1 in response to reception of the “Authentication Information Request.” HSS 6 searches, for example, an IMSI included in the “Authentication Information Request” and executes authentication of a user of the terminal 1A based on the search result. The control unit 61 of the HSS 6 searches, for example, the subscriber information database 60 for the IMSI included in the “Authentication Information Request”. For example, based on the IMSI included in the “Authentication Information Request”, the control unit 61 may conduct a search of the subscriber information database to find an MNO to which a user of the terminal 1A is subscribing. The control unit 61 executes authentication of a user of the terminal 1, for example, based on the search result.

The HSS 6 transmits, to the MME 5, the search result relating to the MNO to which the user of the terminal 1A is subscribing to the MME 5 by including the search result in an “Authentication Information Answer.” (S3-12).

The MME 5 identifies the terminal 1A as a terminal corresponding to the legacy network based on the “Authentication Information Answer” received from the HSS 6.

The MME 5 identifies that the terminal 1A corresponds to the legacy network by the above-described identification procedure and starts an establishment procedure of an EPS bearer (S3-4). The establishment procedure of an EPS bearer is the same as in the operation example of FIG. 9, and therefore detailed description will be omitted.

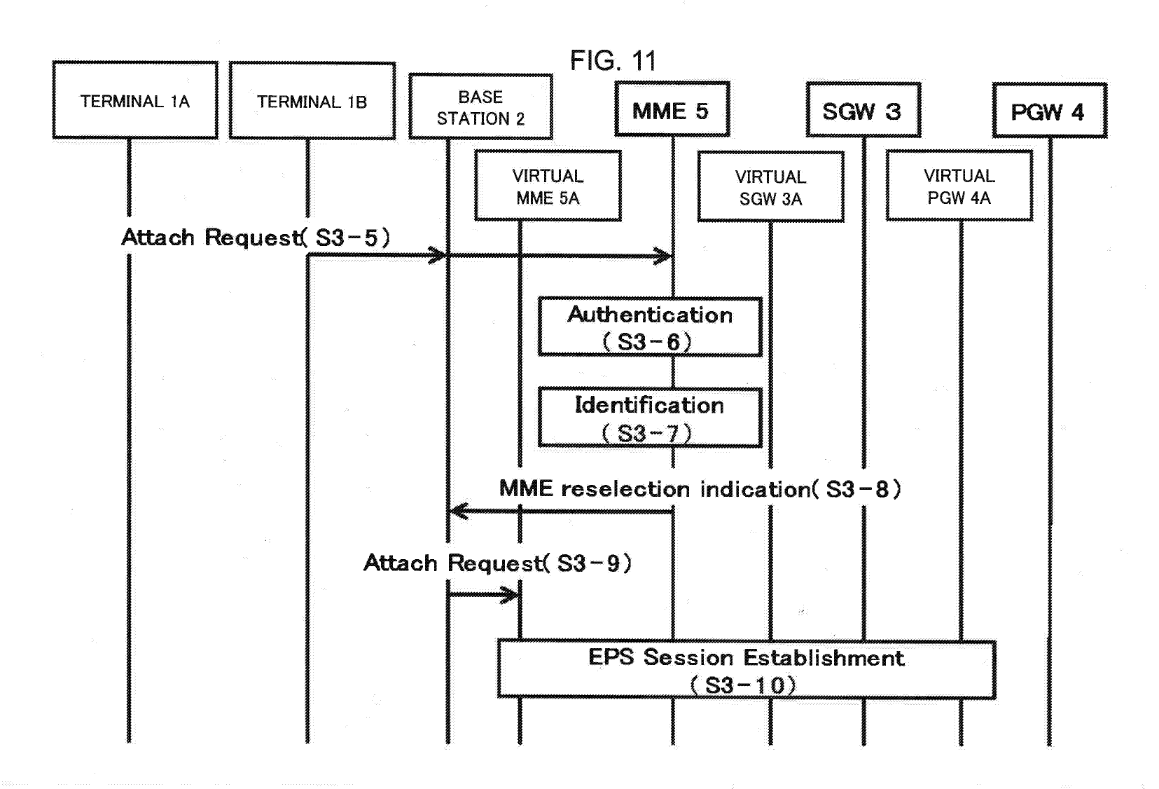

FIG. 11 illustrates an operation example of the terminal 1B corresponding to an MVNO network.

The terminal 1B transmits an “Attach Request” to the base station 2 (S3-5). The base station 2 transmits the “Attach Request” to the MME 5 of the legacy network.

The MME 5 executes an authentication procedure of a terminal in response to reception of the “Attach Request” (S3-6). The MME 5 identifies an attribute/type of the terminal in the authentication procedure based on an IMSI included in the “Attach Request” (S3-7). The authentication procedure for identifying a terminal attribute/type by the MME 5 is the same as the authentication procedure illustrated in FIG. 9, and therefore detailed description will be omitted.

The MME 5 identifies that the terminal 1B corresponds to an MVNO network by the above-described identification procedure and causes the base station 2 to reselect an MME (S3-8, “MME Reselection Indication”).

The MME 5 incorporates, for example, information relating to an MME to be reselected by the base station 2 in an “MME Reselection Indication” and transmits the indication to the base station 2. The MME 5 incorporates, for example, an IP address of an MME (the virtual MME 5A) of an MVNO network in the “MME Reselection Indication.”

The base station 2 transmits an “Attach Request” to the reselected MME in response to reception of the “MME Reselection Indication” (S3-9). The base station 2 reselects, for example, the virtual MME 5A. The base station 2 transmits the “Attach Request” to the reselected virtual MME 5A.

In response to reception of the “Attach Request,” the virtual MME 5A starts a construction procedure of an EPS bearer in the MVNO network. (S3-10). An establishment procedure of an EPS bearer is the same as in the operation example of FIG. 10, and therefore detailed description will be omitted. The terminal 1B communicates with the Internet and the like via the EPS bearer constructed in a virtual network.

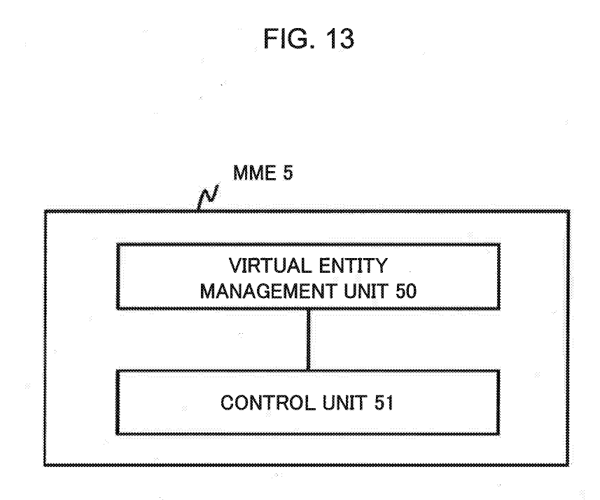

FIG. 13 illustrates a configuration example of the MME 5 of the second example embodiment. The MME 5 includes a function of requesting the base station 2 to reselect an MME based on a network (or a network operator) corresponding to a terminal or an attribute/type of a terminal.

The MME 5 includes a virtual entity management unit 50 and a control unit 51.

The virtual entity management unit 50 manages, for example, an address (an IP address or the like) of the virtual MME 5A disposed on an MVNO network.

The control unit 51 acquires an address of the virtual MME 5A from the virtual entity management unit 50 when a terminal having transmitted an “Attach Request” to the MME 5 is a terminal corresponding to an MVNO network. The control unit 51 transmits the acquired IP address to the base station 2 and requests the base station 2 to reselect an MME. The base station 2 retransmits the “Attach Request” to the virtual MME 5A of the IP address notified from the control unit 51.

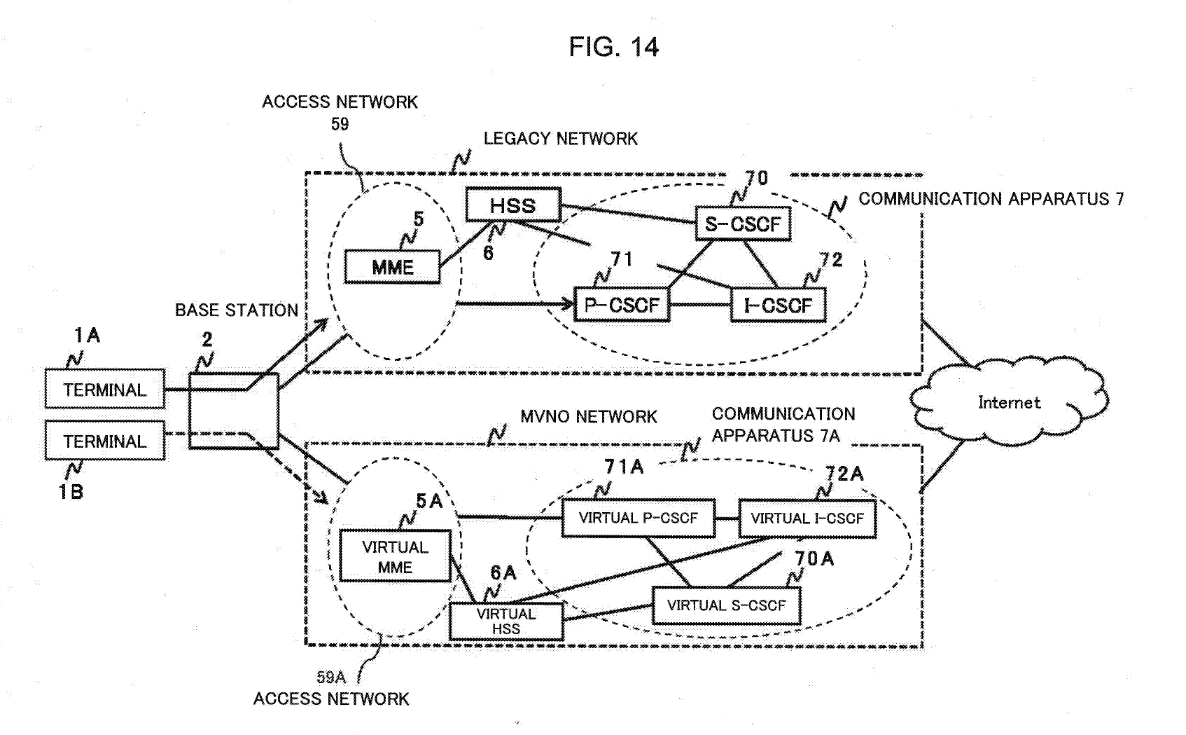

FIG. 14 is another configuration example of the communication system of the second example embodiment. The communication system exemplarily illustrated in FIG. 14 includes, for example, terminals 1A and 1B, a base station 2, a legacy network, and an MVNO network.

The legacy network includes, for example, an access network 59, an HSS 6, a communication apparatus 7 (for example, an S-CSCF 70, a P-CSCF 71, and an I-CSCF 72). The access network 59 includes an MME 5. The MME 5 processes control signaling in conjunction with the HSS 6 that manages subscriber information of the communication system. The communication apparatus 7 is a CSCF that provides a session control function in an IMS network. The MME 5, the HSS 6, and the communication apparatus 7 have the same configurations as the MME 5, the HSS 6, and the communication apparatus 7 illustrated in FIG. 5, respectively, and therefore detailed description will be omitted.

The MVNO network includes, for example, an access network 59A, a virtual HSS 6A, a communication apparatus 7A (for example, a virtual S-CSCF 70A, a virtual P-CSCF 71A, and a virtual I-CSCF 72A). The access network 59A includes a virtual MME 5A. The virtual MME 5A, the virtual HSS 6A, and the communication apparatus 7A have the same configurations as the MME 5, the HSS 6, and the communication apparatus 7 included in the legacy network, respectively, and therefore detailed description will be omitted.

In the above-described examples of the second example embodiment, network nodes included in an MVNO network are virtually operated by software and the like. Therefore, an MNO that manages an MVNO network can construct easily and at low cost network nodes that provide a function of a backbone network such as EPC and the like using software.

### Third Example Embodiment

In a third example embodiment of the present invention, a part of a function of a base station 2 is virtually operated using software and the like. A technique of the third example embodiment is applicable to any of the first and second example embodiments and an example embodiment to be described later.

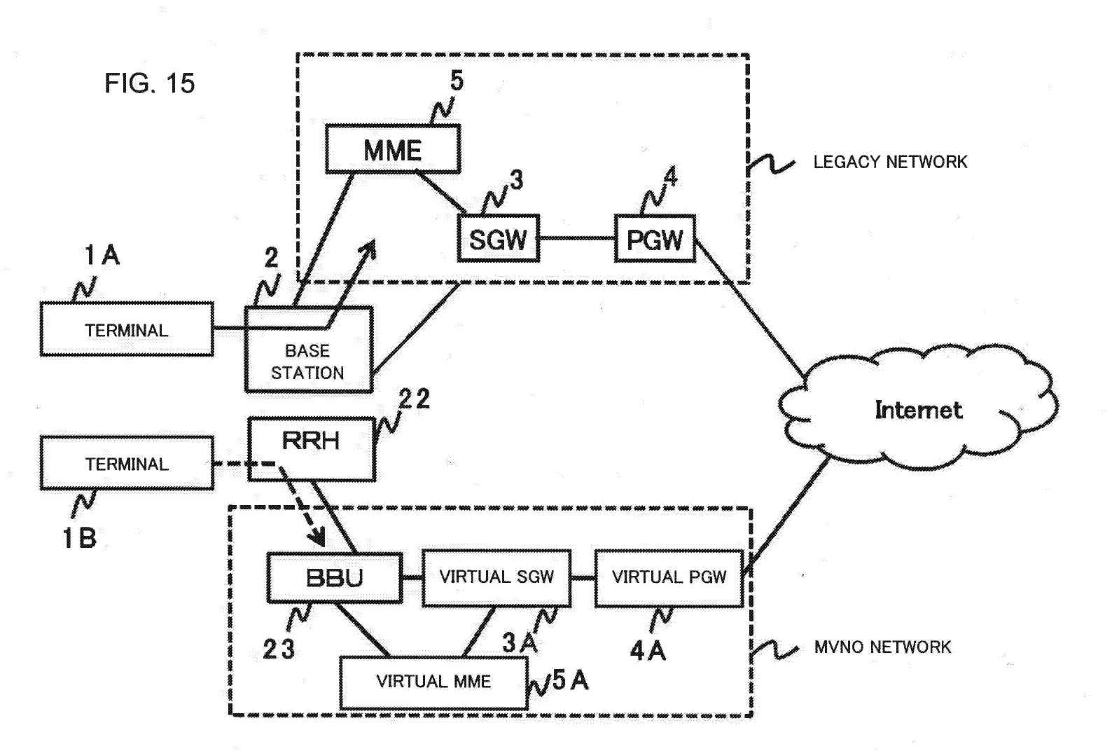

FIG. 15 illustrates a configuration example of a communication system of the third example embodiment.

As exemplarily illustrated in FIG. 15, the communication system of the third example embodiment includes an RRH (Remote Radio Head: wireless unit) 22 and a BBU (Base Band Unit: base band processing unit) 23. In the communication system exemplarily illustrated in FIG. 15, the RRH 22 is managed by an MNO that manages a legacy network, and the BBU 23 is managed by an MVNO. The RRH 22 may be managed not by an MNO that manages a legacy network but by an MVNO. The BBU 23 may be connected to a plurality of RRHs 22. The RRH 22 executes Radio Frequency (RF) signal processing. The BBU 23 executes base band signal processing.

The RRH 22 handles analog RF signal processing and provides an air interface to a mobile station. The analog RF signal processing includes D/A (Digital/Analog) conversion, A/D (Analog/Digital) conversion, frequency up-conversion, frequency down-conversion, amplification, and the like.

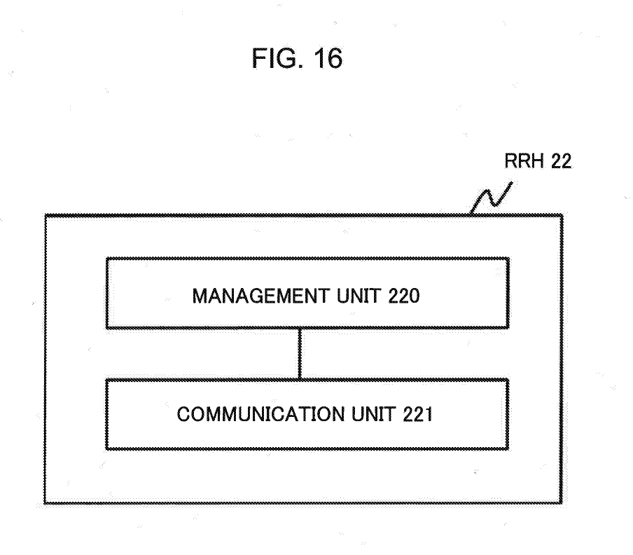

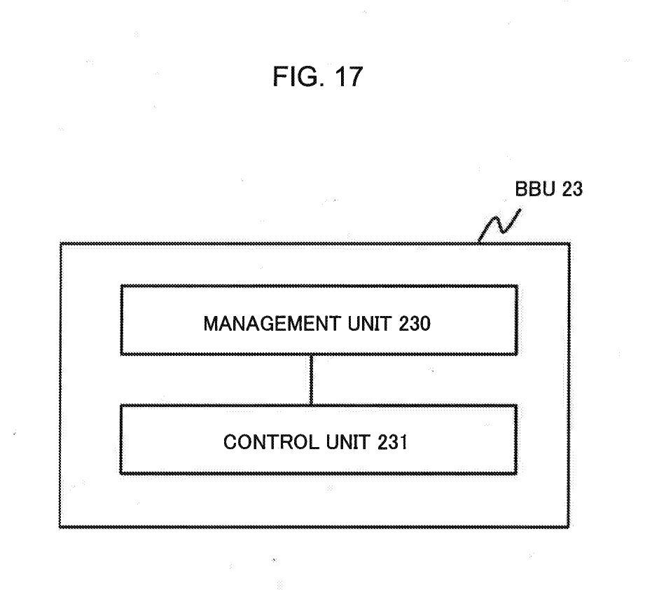

FIG. 16 illustrates a configuration example of the RRH 22 of the third example embodiment. As exemplarily illustrated in FIG. 17, the RRH 22 includes a management unit 220 and a communication unit 221.

The management unit 220 manages information relating to the BBU 23 managed by an MVNO. The management unit 220 manages, for example, identification information (for example, an address of the BBU 23) relating to the BBU 23. Further, the management unit 220 may associate, for example, identification information of the BBU 23 with a flag indicating whether the BBU 23 is a network node included in an MVNO network.

The communication unit 221 refers to the management unit 220 and communicates with the BBU 23 operated by the MVNO. The communication unit 221 refers to the management unit 220 and transfers communication traffic from the terminal 1B to the BBU 23. The communication unit 221 refers to the management unit 220 and transfers communication traffic from the terminal 1B to the BBU 23, for example, based on predetermined information included in a connection request from the terminal 1B. The communication unit 221 refers to the management unit 220 and transfers communication traffic from the terminal 1B to the BBU 23, for example, based on a PLMN ID included in a connection request from the terminal 1B.

The BBU 23 is connected to an upper-level network (for example, a backhaul network or a core network of an MNO), controls and monitors a wireless base station, and executes digital base band signal processing. The digital base band signal processing includes layer-2 signal processing and layer-1 (physical layer) signal processing. The layer-2 signal processing includes at least one of (i) data compression/decompression, (ii) data encryption, (iii) addition/deletion of a layer-2 header, (iv) data segmentation/concatenation, or (v) composition/decomposition of a transfer format by data multiplexing/de-multiplexing. In the case of E-UTRA as one specific example, the layer-2 signal processing includes processing of Radio Link Control (RLC) and Media Access Control (MAC). The E-UTRA is an abbreviation of Evolved Universal Terrestrial Radio Access. The physical layer signal processing includes Channel Coding/Decoding, Modulation/Demodulation, and Spreading/De-spreading. The physical layer signal processing further includes resource mapping and generation of OFDM symbol data (a base band OFDM signal) by Inverse Fast Fourier Transform (IFFT) or the like. The OFDM is an abbreviation of Orthogonal Frequency Division Multiplexing.

A function executed in the BBU 23 can be executed by software such as a virtual machine and the like.

A function provided by the BBU 23 can be operated on a virtual machine, for example, as the VNF 120. The BBU 23 can be operated, for example, by an MVNO in a data center.

FIG. 17 illustrates a configuration example of the BBU 23 of the third example embodiment. As exemplarily illustrated in FIG. 17, the BBU 23 includes a management unit 230 and a control unit 231.

The management unit 230 manages information relating to a virtual network (MVNO network) operated by an MVNO. The management unit 230 manages, for example, information relating to network nodes included in the MVNO network. The management unit 230 manages, for example, identification information (for example, an address of the virtual MME 5A) relating to network nodes included in the MVNO network.

The control unit 231 refers to the management unit 230 and transmits an NAS (Non Access Stratum) message to the virtual MME 5A operated by an MVNO to which the terminal 1B is subscribing.

In the communication system of the third example embodiment, the MVNO may manage the RRH 22. In this case, an MNO that manages a legacy network may rent, for example, a licensed band to the MVNO. The RRH 22 managed by the MVNO communicates with the terminal 1B, for example, using the licensed band rented by the MNO that manages the legacy network.

The RRH 22 may be installed, for example, in a plurality of spots by an MVNO. The MVNO may install the RRH 22, for example, in a large number of spots according to a provided communication service, a usage situation of a service accompanied with the communication service, a use area, and a use range. The MVNO may provide the RRH 22, for example, to a subscriber subscribing to the MVNO for a low price (free of charge in an utmost case).

In the communication system of the third example embodiment, the RRH 22 managed by an MVNO may communicate with the terminal 1B using a frequency band of an unlicensed band.

An operation example of the third example embodiment is the same as the operation example of the first example embodiment illustrated in FIG. 4 or the operation examples of the second example embodiment illustrated in FIG. 9 to FIG. 12, and therefore detailed description will be omitted. The functions of the base station 2 in FIG. 4 or FIG. 9 to FIG. 12 are executed by the RRH 22 and the BBU 23.

In the third example embodiment of the present invention, as described above, a part of the functions of the base station 2 can be virtually operated using software and the like.

### Fourth Example Embodiment

In a fourth example embodiment of the present invention, an MVNO network includes an application that can provide a predetermined service. The fourth example embodiment is applicable to any of the first to third example embodiments.

In a communication system of the fourth example embodiment, an MVNO network includes an application that provides a predetermined service using communication data of a subscriber terminal of the MVNO. An application that provides a predetermined service is included in the MVNO network, and therefore the MVNO can provide the predetermined service using communication data, collected without intermediacy of a legacy network, of a subscriber terminal of the MVNO. Therefore, the MVNO can provide, without passing the communication data of the subscriber terminal of the MVNO to an MNO, the predetermined service using the communication data. In other words, the fourth example embodiment is an example embodiment in which a cloud operator that provides various services holds (manages) an MVNO network.

The MVNO may provide a predetermined service, for example, using communication data transmitted by a plurality of subscriber terminals of the MVNO. The MVNO can provide a predetermined service, for example, using a large amount of communication data collected from a plurality of subscriber terminals. The MVNO may make, for example, a communication charge (usage charge) of a subscriber terminal of the MVNO inexpensive or free of charge, instead of obtaining an income from a service provided using communication data collected from a subscriber terminal. The MVNO can allow, for example, a communication charge of a subscriber terminal of the MVNO to be more inexpensive than that of an MNO to provide this matter as a differentiating factor against the MNO.

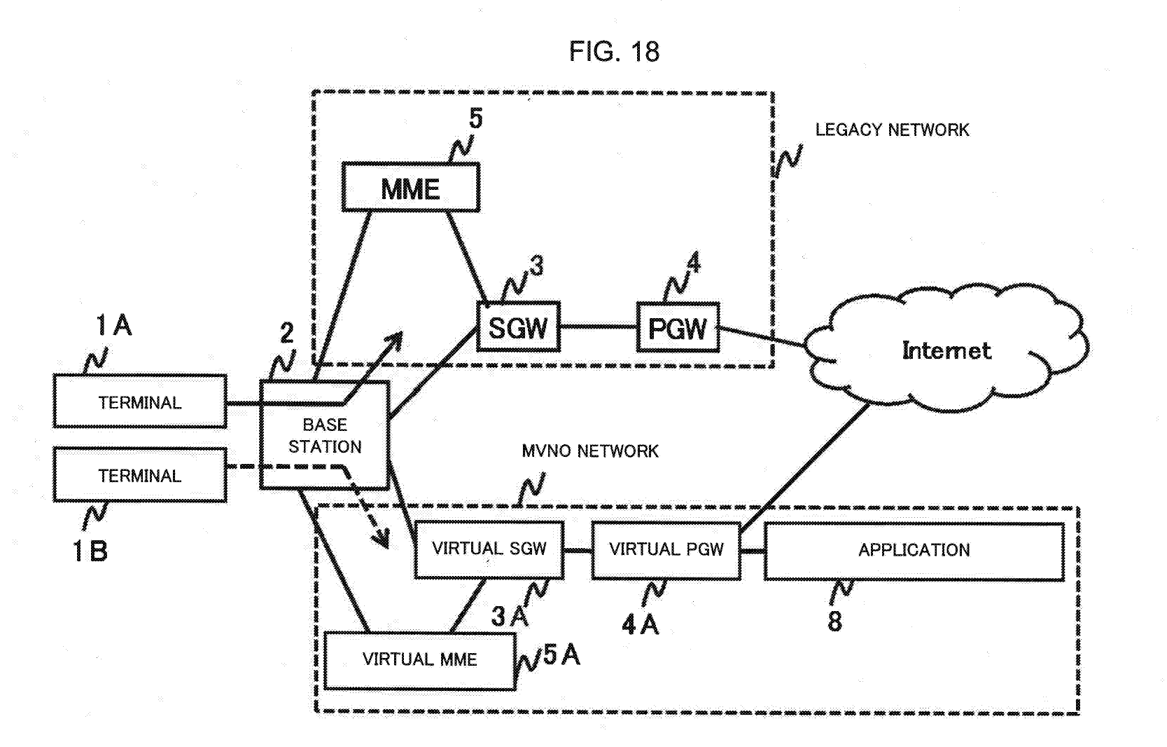

FIG. 18 illustrates a configuration example of the communication system of the fourth example embodiment.

In FIG. 18, a terminal 1B is a device that can collect predetermined data. The terminal 1B is, for example, a device that can collect video data of a monitoring camera or the like. The terminal 1B is, for example, a device that can collect predetermined data of a sensor or the like. The sensor may be a sensor that can sense persons, animals, and the like or a sensor that can sense objects such as automobiles and the like, for example. The terminal 1B may be, for example a smart meter. The terminal 1B may be an automobile, a robot, a drone, medical equipment, or the like. The terminal 1B may be, but not limited to these examples, any device when being a device that can collect predetermined information.

The terminal 1B transmits the collected predetermined data to a base station 2 as communication data. The terminal 1B transmits the collected predetermined data as communication data, for example, at a predetermined cycle. The terminal 1B transmits the collected predetermined data as communication data, for example, at a predetermined timing. The terminal 1B transmits, for example, always the collected predetermined data as communication data. A timing of transmitting, as communication data, predetermined data collected by the terminal 1B is not limited to these examples and may be any timing such as transmission, for example, upon being requested.

In FIG. 18, an MVNO network includes an application 8. The application 8 is, for example, a service providing means that can provide a predetermined service using communication data of a mobile terminal (the terminal 1B). The application 8 is, for example, a service providing means that can provide, by collecting communication data of a mobile terminal (the terminal 1B), a predetermined service based on a data analysis result of the collected data.

Other components (for example, the base station 2) exemplarily illustrated in FIG. 18 are similar to them in the first example embodiment, the second example embodiment, and the third example embodiment, and therefore detailed description will be omitted.

In the communication system exemplarily illustrated in FIG. 18, the service provided by the application 8 includes, for example, the following services.

A service of analyzing a taste of a user and recommending a recommended product from an EC (Electronic Commerce) site
A service of recommending a restaurant according to a behavior history of a user
A service of analyzing congestion situations of trains and roads and presenting an arrival time to a destination
A service of predicting needs for taxies according to physical locations of a plurality of terminals and providing the needs to taxi companies, taxi drivers, and taxi users
A service of analyzing delay situations of trains or buses and providing predicted waiting times of trains or buses to users
A service of analyzing vital information (a body temperature, a blood pressure, a heartbeat, eyesight, the number of steps, a walking distance, a body weight, information relating to blood (for example, a blood sugar level and an oxygen concentration in blood), a bone density, and the like) of a user and providing information relating to health of the user
A service of analyzing vital information (body temperatures, blood pressures, heartbeats, eyesight, numbers of steps, walking distances, body weights, information relating to blood (for example, blood sugar values and oxygen concentrations in blood), bone densities, and the like) of a plurality of users and providing information organized for each area
A service of analyzing video data obtained from a monitoring camera or the like and providing data relating to a suspicious individual or a suspicious object
A service of analyzing video data obtained from a monitoring camera or the like and issuing a notification of occurrence of a disaster
A service of analyzing a consumed power obtained from a smart meter and the like and optimizing power consumption
A service of analyzing location information of a plurality of automobiles and providing information relation to congestion
A service of analyzing data obtained from a nursing care robot and the like and notifying concerned persons such as family members, doctors, and the like of a health state of a person who receives care

Hereinafter, configuration examples of the fourth example embodiment will be described with reference to corresponding drawings.

### Configuration Example 1

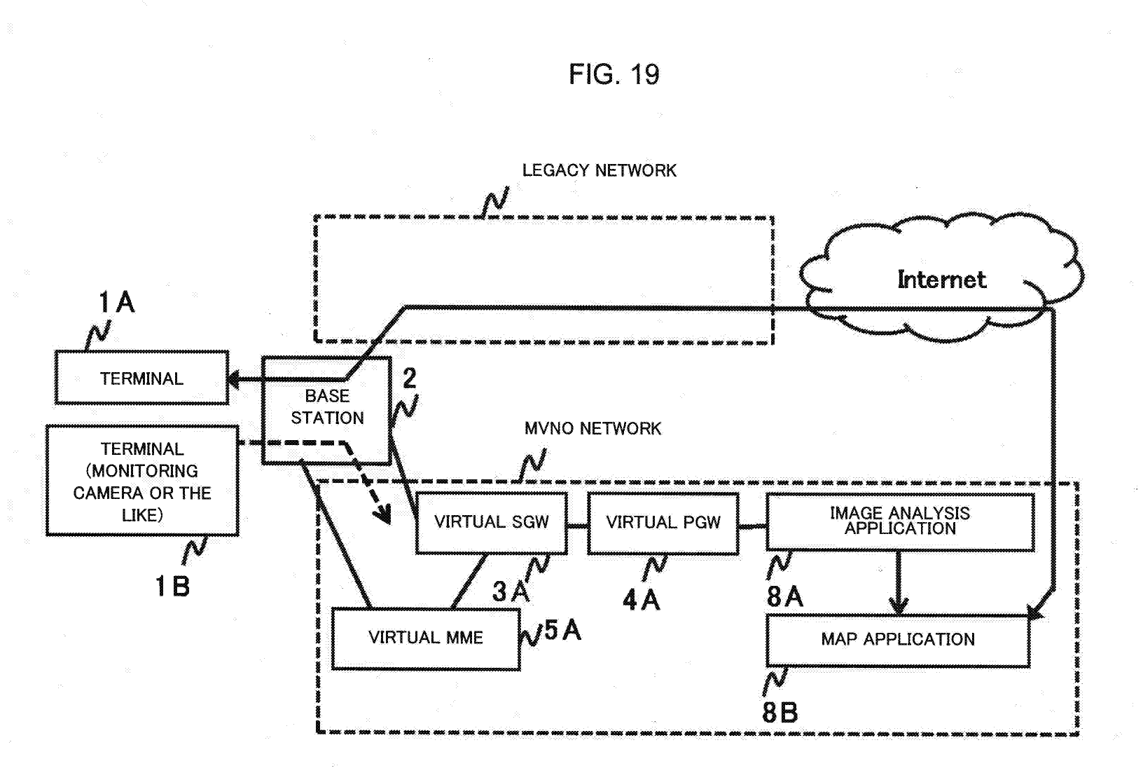

FIG. 19 is a configuration example of a communication system in a configuration example 1 of the fourth example embodiment.

In the communication system exemplarily illustrated in FIG. 19, the terminal 1B is, for example, a device that can collect video data of a monitoring camera or the like. The terminal 1B collects video data and transmits the collected video data to the base station 2 as communication data. The terminal 1B that is a monitoring camera or the like image-captures, for example, a predetermined monitoring area and transmits the captured video data to the base station 2 as communication data. The communication system exemplarily illustrated in FIG. 19 may include a plurality of monitoring cameras or the like (terminals 1B). A plurality of monitoring cameras or the like (terminals 1B) collect video data of different spots, respectively, and transmit the collected video data to the base station 2 as communication data.

In the configuration example 1 of the fourth example embodiment, the terminal 1B that is a monitoring camera or the like is, for example, a company, a municipality, a police station, an individual, or the like that receives service from a cloud operator that possesses an MVNO network. A company, a municipality, a police station, an individual, or the like that receives service provision from a cloud operator may receive, instead of causing an MVNO to use the terminal 1B that is a self-possessed monitoring camera or the like, a value from the MVNO. Further, an MVNO that is a cloud operator may make, when a company, a municipality, a police station, an individual, or the like that receives service possesses a subscriber terminal of the MVNO separately from the terminal 1B, a communication charge of the subscriber terminal inexpensive (or free of charge). Further, the terminal 1B that is a monitoring camera or the like, for example, may be possessed by an MVNO or may be distributed to a company, a municipality, a police station, or an individual at a low price (or free of charge) by the MVNO.

As exemplarily illustrated in FIG. 19, in the communication system of the configuration example 1, the MVNO network includes an image analysis application 8A and a map application 8B.

The image analysis application 8A includes, for example, a function of analyzing video data of a monitoring camera or the like. The image analysis application 8A identifies whether, for example, video data image-captured by a monitoring camera or the like includes an object (a person, an animal, an automobile, or the like) to be monitored. The image analysis application 8A identifies whether, for example, video data image-captured by a monitoring camera or the like includes an abnormal object (for example, a person who covers a part of his/her face or an object (suspicious object) that is not detected in a normal situation). The image analysis application 8A detects, for example, an object making an abnormal movement (for example, an object moving at a predetermined speed or more, an object that has become still (has stopped) suddenly, or an object being still (at stop) for a predetermined period) from video data image-captured by a monitoring camera or the like.

The image analysis application 8A may detect, for example, a state (for example, occurrence of fire or smoke, rise of a river, or occurrence of traffic congestion) different from a normal one from video data image-captured by a monitoring camera or the like.

The image analysis application 8A may analyze, for example, video data image-captured by a plurality of monitoring cameras or the like. The image analysis application 8A may track a movement of an object (a person, an animal, an automobile, or the like) to be monitored from video data image-captured by a plurality of monitoring cameras or the like that monitor different spots, for example. The image analysis application 8A may detect, for example, a range (for example, an occurrence range of traffic congestion) where a state different from a normal one is occurring from video data image-captured by a plurality of monitoring cameras or the like that are installed in different spots.

Contents analyzed by the image analysis application 8A from video data image-captured by a monitoring camera or the like are not limited to these examples and may be contents analyzable using video data.

The map application 8B includes, for example, a function of creating map data in which an analysis result of the image analysis application 8A is displayed on a map. The map application 8B creates, for example, map data in which a spot where an object to be monitored, an abnormal object, or an object making an abnormal movement has been detected is displayed on a map, based on a location of the terminal 1B (a monitoring camera or the like) and an analysis result of the image analysis application 8A. The map application 8B may create, for example, map data in which a spot where a state different from a normal one has occurred is displayed on a map. The map application 8B may create, for example, map data in which a movement (tracking) situation of an object to be monitored or a range where a state (for example, a disaster) different from a normal one is occurring is displayed on a map, based on locations of a plurality of terminals 1B (monitoring cameras or the like) and an analysis result of the image analysis application 8A.

A method/content in which an analysis result of the image analysis application 8A is displayed on a map in map data created by the map application 8B is not limited to these examples and may be any method/content.

As exemplarily illustrated in FIG. 19, in the communication system of the configuration example 1, map data created by the map application 8B is transmitted to the terminal 1A. The map data created by the map application 8B is transmitted, for example, to the terminal 1A that is a subscriber terminal of an MNO via a legacy network. When the terminal 1A is an MVNO subscriber terminal, map data created by the map application 8B is notified to the terminal 1A via an MVNO network. The terminal 1A displays the map data notified via the MVNO network on a screen or the like. The terminal 1A may be any device when including a screen or the like such as a mobile terminal, a PC (Personal Computer), a TV (Television), a screen, a monitor, and the like that can display map data.

When the MVNO network is possessed (managed) by a cloud operator such as Google (a registered trademark) and the like, the map application 8B creates, for example, map data used in Google Map or the like. The terminal 1A displays map data created by the map application 8B using an application such as Google Map and the like for maps.

A plurality of terminals 1B that are monitoring cameras or the like are installed, for example, in commercial facilities such as a shopping center and the like. Each of the plurality of terminals 1B transmits, for example, video data relating to traffic of persons in an installation place to an MVNO network. The image analysis application 8A analyzes, with respect to a specific person who has visited a shopping center, movements (for example, how the person moves and what stores (tenants) the person stops at) of the specific person in the shopping center from video data collected from the plurality of terminals 1B. In this case, the image analysis application 8A may identify movements of a specific person from video data collected from a plurality of terminals 1B, for example, using face recognition technology. The image analysis application 8A analyzes movements in the shopping center with respect to a plurality of persons and obtains statistical information, for example, for each age and/or each gender. The image analysis application 8A obtains statistical information relating to, for example, how men in their twenties who have visited the shopping center move and what stores (tenants) they have stopped at. The map application 8B creates, based on the statistical information notified from the image analysis application 8A, map data for displaying movement situations in the shopping center, for example, for each age and/or each gender on a map of the shopping center. The map application 8B transmits the created map data to the terminal 1A possessed, for example, by a company that operates the shopping center. The company that operates the shopping center can change dispositions of stores, advertisements to be displayed, or the like based on movement situations of persons in the shopping center displayed on the terminal 1A. The company that operates the shopping center can determine that, for example, stores (tenants) which men in their twenties visit in the shopping center are concentrated and a store such as a coffee shop and the like which many women use is disposed between stores which women visit. Further, the company that operates the shopping center can also determine that, for example, advertisements for men in their fifties are displayed in a digital signage in a periphery of stores that men in their fifties visit. In this manner, a cloud operator that possesses (manages) an MVNO network can provide information relating to marketing, for example, to a company that operates a shopping center or the like.

### Configuration Example 2

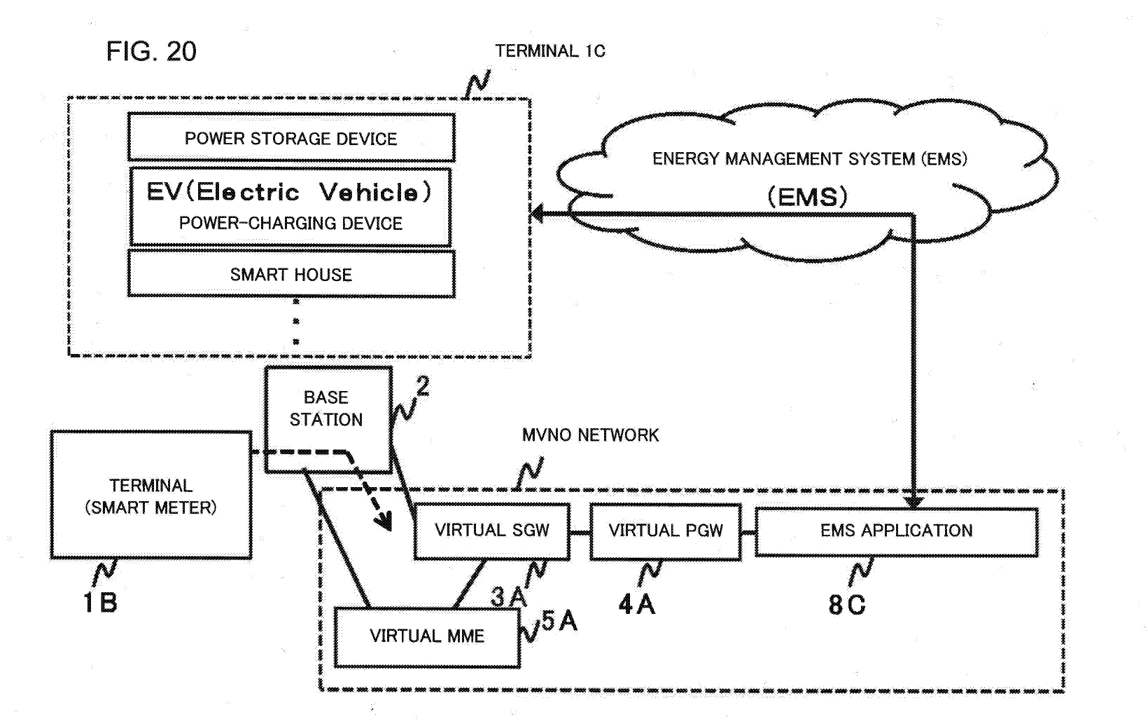

FIG. 20 is a configuration example of a communication system in a configuration example 2 of the fourth example embodiment. The configuration example 2 is a configuration example in which, for example, a cloud operator provides an energy management system as a service.

In the communication system exemplarily illustrated in FIG. 20, the terminal 1B is a device such as a smart meter or the like that can collect information relating to power (consumed power, stored power, and generated power), for example. The information relating to power may be any information when being, for example, information relating to power such as a power amount, a predicted power amount, a power amount per unit time, and the like. Further, the terminal 1B may be, for example, a device that can collect information relating to surplus power determined from consumed power, generated power, and the like.

The terminal 1B collects, for example, information relating to consumed power of a predetermined apparatus in a house (home), a company, or a predetermined building (a building or a store) or information relating to consumed power in the house (home), the company, or the predetermined building (a building or a store) and transmits the collected information relating to consumed power to the base station 2. The terminal 1B such as a smart meter and the like may be, for example, a device that can collect information relating to a predicted value (estimated value) of consumed power. The terminal 1B transmits information relating to a predicted value (estimated value) of the consumed power to the base station 2.

The terminal 1B may be, for example, a device that can collect information relating to power (generated power) generated by a predetermined power generation apparatus (a solar power generation apparatus, a wind power generation apparatus, or the like) in a house (home), a company, or a predetermined building (a building or a store). Further, the terminal 1B may be, for example, a device that can collect information relating to power stored by a storage system (for example, a secondary battery or a battery in an EV (Electric Vehicle)) in a house (home), a company, or a predetermined building (a building or a store). The terminal 1B transmits information relating to power that has been generated (generated power) or information relating to power that has been stored (stored power) to the base station 2.

The terminal 1B may be, for example, a device that can collect information relating to surplus power determined from consumed power, stored power, and generated power in a house (home), a company, or a predetermined building (a building or a store). The terminal 1B transmits, for example, information relating to the surplus power to the base station 2.

As exemplarily illustrated in FIG. 20, in the communication system of the configuration example 1, the MVNO network includes an EMS (Energy Management System) application 8C. The EMS application 8C includes a function of realizing an EMS.

The EMS is a system that optimizes power usage of a house (home), an office building, a factory, or the like using ICT (Information Communication Technology). The EMS monitors, for example, a consumed power amount for illumination, air conditioning, and the like, a stored power amount by a power storage apparatus, a generated power amount by a power generation apparatus, and the like and manages an energy situation in a house, a building, or in a building such as a factory and the like (or in a company), based on the monitored power amounts. The EMS predicts, for example, a power demand in a building (or in a company) based on a managed energy situation. The EMS controls, for example, devices (illumination, air conditioning, and the like) that consume power in a building (or in a company) based on the predicted power demand and performs optimization of power consumption (for example, minimization of consumed power) in the building (or in the company). The EMS includes an HEMS (Home EMS) for the inside of a home (the inside of a house) and a BEMS (Building EMS) for an office building and the like. In the configuration example 2, the EMS application 8C may be either for the HEMS or for the BEMS. The EMS application 8C may be any EMS such as an EMS for cities and the like, for example.

The EMS application 8C includes, for example, a function of optimizing power consumption in a home (a house) or an office building (a store, a company, or the like), based on information relating to power collected from the terminal 1B such as a smart meter and the like.

The EMS application 8C creates, for example, display data for displaying a consumed power situation in a house (home), a company, or a predetermined building (a building or a store), based on information relating to consumed power collected from the terminal 1B such as a smart meter and the like and notifies the terminal 1C of the created display data. The EMS application 8C may determine, for example, a predicted value of consumed power in a house (home), a company, or a predetermined building (a building or a store) based on information relating to collected consumed power, create display data for displaying the predicted value, and transmit the created display data to the terminal 1C. The terminal 1C can realize visualization of a measured value or a predicted value of consumed power by displaying the notified display data.

The EMS application 8C may transmit, for example, an instruction with respect to power to the terminal 1C based on information relating to power collected from the terminal 1B. The EMS application 8C instructs, for example, the terminal 1C that is a power storage device to sell stored power or start power storage based on a measured value or a predicted value for a demand or supply of power. The EMS application 8C instructs, for example, the terminal 1C to start power storage in a time zone having less consumed power and start power discharging (selling power and the like) in a time zone having much consumed power and thereby can optimize consumed power as a whole (for example, in the whole house, company, or predetermined building). Thereby, the EMS application 8C can reduce, for example, a peak power of a time zone having much consumed power in a house, a building, or in a building such as a factory and the like (or in a company).

The EMS application 8C instructs, for example, the terminal 1C that is an EV power-charging device to start power charging based on a measured value or a predicted value for a demand or supply of power. The EMS application 8C instructs an EV to start power charging in a time zone having less consumed power and instructs the EV to stop power charging in a time zone having much consumed power, and thereby can optimize power consumption, for example, in a home (a house) that possesses an EV power-charging device or in a company or a predetermined building.

The EMS application 8C instructs, for example, the terminal 1C that is a power storage device (a home secondary battery or the like) or a power generation device (a solar power generation apparatus or the like) in a smart house to start selling power based on a measured value or a predicted value for a demand or supply of power. Further, the EMS application 8C instructs, for example, a power storage device, an EV power-charging device, or the like to start power charging based on a measured value or a predicted value for a demand or supply of power. The EMS application 8C issues an instruction, for example, for starting power storage or power charging in a time zone having less consumed power and issues an instruction for stopping power storage or power charging or, alternatively, starting power discharging (selling power or the like) in a time zone having much consumed power, and thereby can optimize consumed power as a whole in a smart house.

The EMS application 8C may issue an instruction, for example, with respect to power to a plurality of terminals 1C based on information relating to power collected from a plurality of terminals 1B. In this case, the EMS application 8C can optimize, for example, consumed power in a plurality of buildings including the terminal 1C. The EMS application 8C manages/controls consumed power in the entire city (a smart city) and supplies, for example, power to an area having deficient power in the city from an area having surplus power, and thereby can optimize consumed power in a wide range.

The EMS application 8C may notify an external EMS server of data (information) in which information relating to consumed power collected from the terminal 1B and a collecting clock time are associated. The external EMS server stores the data (information) in which information relating to consumed power and a collecting clock time are associated as history data. The EMS application 8C may collect information relating to consumed power from a plurality of terminals 1B and notify, with respect to the plurality of terminals 1B, an external EMS server of the data (information) in which information relating to consumed power and a collecting clock time are associated. In this case, the external EMS server stores, for each of the plurality of terminals 1B, the data (information) in which information relating to consumed power and a collecting clock time are associated as history data. The external EMS server issues an instruction with respect to power to the terminal 1C, for example, based on the stored history data. The external EMS server issues an instruction based on the history data and thereby can optimize consumed power of the terminal 1C.

The EMS application 8C may convert, for example, information relating to consumed power collected from the terminal 1B to data of a format usable by an external EMS server and notify the external EMS server of the data. The EMS application 8C executes conversion of a format of data, and thereby a cloud operator that manages the EMS application 8C can provide information relating to consumed power collected from the terminal 1B to an administrator that manages an external EMS server. When formats of data are the same in the EMS application 8C and an external EMS server, it is unnecessary to convert the formats of data.

The EMS application 8C issues an instruction for power to the terminal 1C that is a subscriber terminal of an MNO, for example, via a legacy network. When the terminal 1C is an MVNO subscriber terminal, the EMS application 8C may issue an instruction for power via an MVNO network. Further, the EMS application 8C notifies an external EMS server of data (information) relating to consumed power via a legacy network or an MVNO network.

### Configuration Example 3

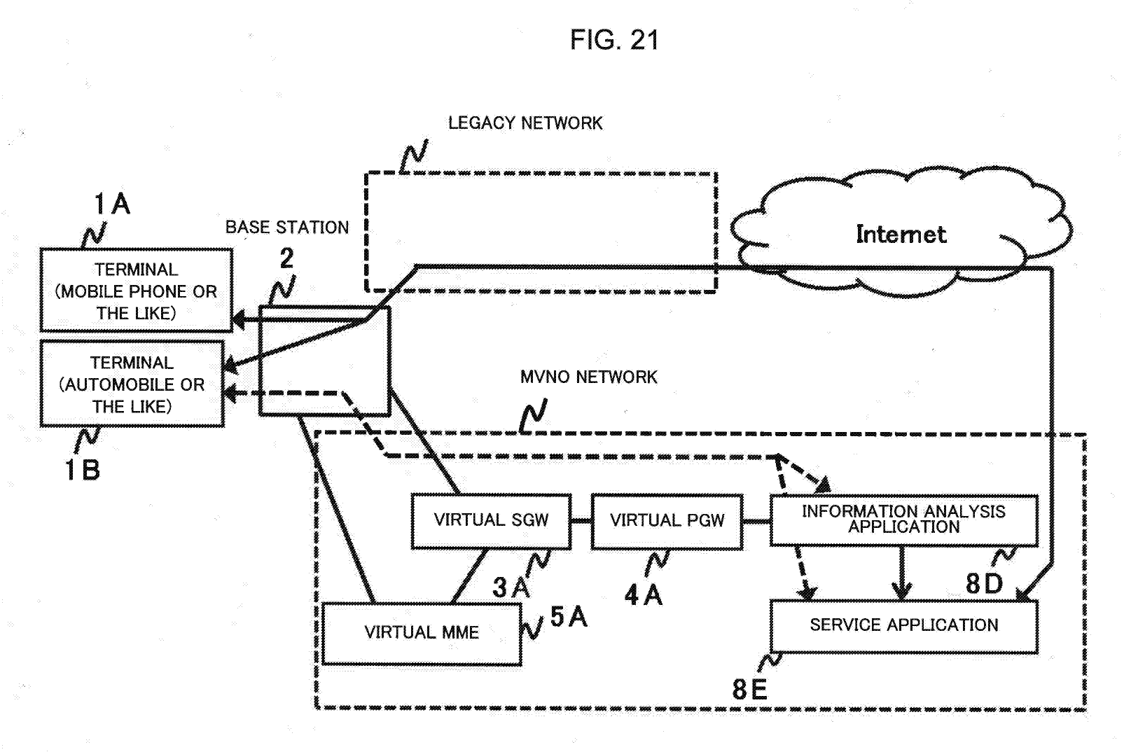

FIG. 21 is a configuration example of a communication system in a configuration example 3 of the fourth example embodiment.

In the communication system exemplarily illustrated in FIG. 21, the terminal 1B is included, for example, in an automobile or the like and is a device that can detect/collect location information of the automobile or the like. The terminal 1B is included, for example, in an automobile or the like and is a device that can detect/collect fuel mileage information of the automobile or the like and information relating to fuel such as a fuel remaining amount and the like. The terminal 1B collects predetermined information such as location information, information relating to fuel, and the like and transmits the collected predetermined information to the base station 2 as communication data. As exemplarily illustrated in FIG. 21, in the communication system of the configuration example 3, the MVNO network includes an information analysis application 8D and a service application 8E. Further, as exemplarily illustrated in FIG. 21, the communication system of the configuration example 3 includes terminals 1A and 1B.

The information analysis application 8D includes, for example, a function of analyzing information from the terminal 1B. The information analysis application 8D analyzes, for example, location information of an automobile or the like notified from the terminal 1B and determines a current location of the automobile or the like. The information analysis application 8D analyzes, for example, information relating to fuel of an automobile or the like notified from the terminal 1B and estimates a time or a location at which the fuel runs out.

The information analysis application 8D may estimate, for example, based on information (a remaining amount of a battery, a free capacity of a battery, or the like) relating to a battery of an electric vehicle notified from the terminal 1B, a time or a location (a time or a location at which the battery becomes dead) at which it is necessary to charge the battery of the electric vehicle. Further, the information analysis application 8D may estimate, for example, based on information (a remaining amount of hydrogen, a free capacity of hydrogen, or the like) relating to fuel (hydrogen) of a fuel vehicle notified from the terminal 1B, a time or a location at which the fuel (hydrogen) runs out.

The service application 8E includes a function of providing a predetermined service, for example, based on information from the terminal 1B and/or an analysis result of the information analysis application 8D. The service application 8E determines, for example, based on an analysis result of information relating to a location of an automobile or the like, an optimum route (for example, a shortest route or a most inexpensive route) to a destination of the automobile or the like and creates data for guiding the optimum route. The service application 8E notifies the terminal 1A that is a mobile terminal, a PC, or a car navigation system (an apparatus that provides car navigation) of the created data for guiding the optimum route.

The service application 8E may create, for example, based on information relating to a location of an automobile or the like, control data for autonomously driving the automobile or the like and notify the automobile or the like that is the terminal 1B of the created control data. The automobile or the like that is the terminal 1B autonomously drives itself based on the control data for autonomous driving.

The service application 8E creates, for example, based on an analysis result of information relating to fuel (gasoline or hydrogen) of an automobile or the like from the terminal 1B, data for displaying a location of a gas station (or a hydrogen station) and notifies the terminal 1A that is a mobile terminal or a car navigation system of the created data. The service application 8E may determine an optimum route to a gas station (or a hydrogen station) from a current location of the automobile and create data for guiding the optimum route. The service application 8E may notify, for example, the terminal 1A of the created data for guiding the optimum route.

The service application 8E may create, for example, based on an analysis result of information relating to a battery of an electric vehicle from the terminal 1B, data for displaying a location of an electricity station and notify the terminal 1A of the created data. The service application 8E may determine an optimum route to a charging station from a current location of an electric vehicle and create data for guiding the optimum route.

The service application 8E may create data for displaying candidates for gas stations (or a hydrogen stations or a charging stations) based on information relating to a location of an automobile or the like, information relating to fuel or a battery of the automobile or the like, and map data and notify the terminal 1A of the created data.

The information analysis application 8D may include, for example, a function of analyzing information from a plurality of terminals 1B (for example, automobiles), and the service application 8E may include a function of providing a service based on an analysis result of the information from the plurality of terminals 1B. The information analysis application 8D analyzes, for example, a congestion situation and the like based on information relating to locations of a plurality of automobiles and the like. The service application 8E creates, for example, based on the congestion situation analyzed by the information analysis application 8D, data for notifying a predetermined system (for example, Twitter (a registered trademark) and a traffic information system) of information relating to the congestion situation and detour routes. The service application 8E notifies, for example, the terminal 1A that provides a predetermined system (for example, a car navigation system) of the created data.

The information analysis application 8D may accumulate, for example, information relating to a location of an automobile or the like collected from the terminal 1B and analyze driving information of the automobile or the like. The information analysis application 8D accumulates and analyzes, for example, information relating to locations of a plurality of automobiles and the like collected from a plurality of terminals 1B, and thereby can obtain a situation of a travelable road. The service application 8E creates, for example, map data for displaying, on a map, the situation of the travelable road obtained by the information analysis application 8D and notifies the terminal 1A of the created map data. The terminal 1A displays a road operation situation notified from the service application 8E on a map such Google MAP and the like and thereby can provide, to a user of an automobile or the like, for example, information (traffic result information) relating to a travelable road after an earthquake, a typhoon, or an earthquake disaster such as tsunami or in a conflict area.

Further, the information analysis application 8D may accumulate, for example, information in which information relating to locations of a plurality of automobiles and the like collected from a plurality of terminals 1B and a clock time of collecting the information are associated and analyze driving information of the automobiles and the like for each time. The information analysis application 8D can obtain, for example, an operation situation of automobiles and the like in a predetermined road for each time. The service application 8E creates, for example, data for displaying an operation situation of automobiles and the like in a predetermined road for each time (for example, each time zone such as day, night, and the like) and notifies the terminal 1A of the created data. The terminal 1A displays an operation situation of automobiles and the like in a predetermined road for each time (or each time zone), and thereby a user of the terminal 1A can determine that, for example, public safety is well-maintained (there are a large number of operations of automobiles and the like) or poor (there are a small number of operations of automobiles and the like) for each time (or each time zone).

In the configuration example 3 of the fourth example embodiment, the terminal 1B is, for example, an unmanned aerial vehicle (Drone) or a self-driving vehicle or may be a device that delivers or collects cargo. The terminal 1B is, for example, a small-unmanned aerial vehicle (Drone) by which Amazon (a registered trademark) delivers cargo. The terminal 1B that is a Drone or a self-driving vehicle detects (collects), for example, location information of the terminal 1B and transmits the location information to the base station 2 as communication data. The terminal 1B that is a Drone or a self-driving vehicle collects, for example, information relating to an operation situation of the terminal 1B and transmits the information to the base station 2. The terminal 1B that is a Drone or a self-driving vehicle detects, for example, a battery remaining amount of the terminal 1B and transmits the detected information to the base station 2.

The information analysis application 8D identifies, for example, based on location information of the terminal 1B notified from the terminal 1B, a current location of the terminal 1B. The service application 8E creates, for example, data for controlling flight or driving of the terminal 1B that is a Drone or a self-driving vehicle based on the current location of the terminal 1B identified by the information analysis application 8D. The service application 8E notifies the terminal 1B that is the Drone or the self-driving vehicle of the data for controlling flight or driving of a Drone or a self-driving vehicle. The terminal 1B that is a Drone or a self-driving vehicle autonomously drives itself based on the notified control data. The service application 8E creates, for example, based on a current location of the terminal 1B identified by the information analysis application 8D, data for displaying the current location of the terminal 1B on a map. The service application 8E notifies, for example, the terminal 1A such as a mobile phone, a PC, a monitor, and the like of the data for displaying a current location of the terminal 1B on a map. The terminal 1A displays the current location of the terminal 1B on a map based on the notified data.

The service application 8E may create, for example, based on a collection/delivery situation of cargo (cargo for delivery), control data for moving the terminal 1B that is a Drone or a self-driving vehicle to a collection place or a delivery place. The service application 8E receives, for example, a notification of information relating to a collection/delivery situation of cargo (cargo for delivery) from an external apparatus (not illustrated), creates, for example, control data for dispatching (moving) the terminal 1B from an identified current positon of the terminal 1B to a spot or an area (a house, a building, or the like) where a collection request for cargo has been made, and notifies the terminal 1B of the control data. The terminal 1B that is a Drone or a self-driving vehicle moves to the spot or the area where the collection request for cargo has been made based on the notified control data.

The information analysis application 8D may detect/identify, for example, based on information notified from a plurality of terminals 1B relating to operation situations of the terminals 1B, operation situations of the plurality of terminals 1B. The service application 8E determines, for example, based on operation situations of a plurality of terminals 1B and information relating to a collection/delivery situation of cargo (cargo for delivery) from an external apparatus (not illustrated), the terminal 1B to be dispatched to a place or an area (a house, a building, or the like) where a collection request for cargo has been made. The service application 8E creates, for the determined terminal 1B, control data for dispatching (moving) the terminal 1B to the place or the area (a house, a building, or the like) where the collection request for cargo has been made and notifies the terminal 1B that is a Drone or a self-driving vehicle of the created control data.

The information analysis application 8D may analyze (predict), for example, based on data of a battery remaining amount situation notified from the terminal 1B, a time necessary for replacing or charging a battery of the terminal 1B or a place where the battery becomes dead. The service application 8E determines, based on a time necessary for replacing or charging a battery, a charging place or a charging time of a battery of the terminal 1B that is a Drone or a self-driving vehicle and creates control data for controlling flight or driving of the terminal 1B. The service application 8E notifies the terminal 1B of the created control data. The terminal 1B that is a Drone or a self-driving vehicle moves to a predetermined place at a predetermined time to charge the battery based on the notified control data.

The information analysis application 8D may receive a notification of information relating to cellular communication being performed by the terminal 1B that is a Drone or a self-driving vehicle and analyze whether the terminal 1B is intruding into a flight-prohibited area (for example, an airport periphery) or a travel-prohibited area (for example, private property). The service application 8E creates, when the terminal 1B that is a Drone or a self-driving vehicle is intruding into a flight-prohibited area or a travel-prohibited area, control data for leaving (moving) from the prohibited area and notifies the terminal 1B of the created control data. The terminal 1B that is a Drone or a self-driving vehicle autonomously leaves from the prohibited area based on the notified control data.

In the configuration example 3 of the fourth example embodiment, the terminal 1B may be, for example, a robot or medical equipment. The robot is an industrial robot, a home nursing care robot, or the like. When the terminal 1B is, for example, a home nursing care robot, the terminal 1B is disposed in a home or a hospital, collects information relating to a person who receives care, and transmits the collected information to the base station 2. When the terminal 1B is, for example, medical equipment, the terminal 1B collects data of examination information (a body temperature, a blood pressure, a heartbeat, eyesight, the number of steps, a walking distance, a body weight, information relating to blood (for example, a blood sugar value and an oxygen concentration in blood), a bone density, and the like) of a subject and transmits the collected data to the base station 2. The terminal 1B that is medical equipment is, for example, a pulse oximeter and collects information relating to an oxygen concentration in blood of a subject. Further, the terminal 1B may be, for example, a wearable device, collects vital information (a body temperature, a blood pressure, a heartbeat, eyesight, the number of steps, a walking distance, a body weight, information relating to blood (for example, a blood sugar value and an oxygen concentration in blood), a bone density, and the like) of a user from a wristwatch-type wearable device (a device which a user can wear or the like), and transmits the collected information to the base station 2. Further, the terminal 1B may be, for example, a communication module implanted in a living body. In this case, the terminal 1B collects, for example, data of biological information (for example, a pulse beat) and transmits the collected data to the base station 2.

The information analysis application 8D analyzes, for example, information relating to a person who receives care notified from the terminal 1B, creates information (for example, information relating to a health state of the person) relating to the person, and notifies the service application 8E of the created information. The service application 8E creates, for example, display data for displaying information relating to the person who receives care based on the information notified from the information analysis application 8D and notifies the terminal 1A such as a mobile phone, a PC, a monitor and the like of the created data. The terminal 1A is possessed, for example, by a concerned person of the person who receives care such as a family member of the person who receives care, a doctor, and the like. The terminal 1A displays, based on the notified data, information (for example, information relating to the health state of the person who receives care) relating to the person who receives care.

The information analysis application 8D analyzes, for example, examination information or biological information of a subject notified from the terminal 1B, creates information (for example, information relating to a health state of the subject) relating to the subject, and notifies the service application 8E of the created information. The service application 8E creates, for example, display data for displaying information relating to the subject based on the information notified from the information analysis application 8D and notifies the terminal 1A such as a mobile phone, a PC, a monitor and the like possessed by the subject of the created data. The terminal 1A displays, based on the notified data, information (for example, information relating to a health state of a subject) relating to the subject.

The service application 8E notifies, for example, the terminal 1A that is a subscriber terminal of an MNO of predetermined data via a legacy network. When the terminal 1A is an MVNO subscriber terminal, the service application 8E may make a notification of predetermined data via an MVNO network.

As described above, in the communication system of the fourth example embodiment, an MVNO network includes an application that provides a predetermined service using communication data of a subscriber terminal of the MVNO. Therefore, an MVNO can provide a predetermined service using communication data of a subscriber terminal of the MVNO collected without intermediacy of a legacy network. Therefore, an MVNO can provide, without transferring communication data of a subscriber terminal of the MVNO to an MNO, a predetermined service using the communication data. Further, an MVNO may make, for example, a communication charge (usage charge) of a subscriber terminal of the MVNO inexpensive or free of charge, instead of obtaining an income from a service provided using communication data collected from a subscriber terminal. An MVNO can make, for example, a communication charge of a subscriber terminal of the MVNO to be more inexpensive than that of an MNO to provide this matter as a differentiating factor against the MNO.

While example embodiments of the present invention have been described, the present invention is not limited to the above-described example embodiments. The present invention can be carried out based on variations, substitutions, and adjustments of the example embodiments. Further, the present invention can be carried out by optionally combining the example embodiments. In other words, the present invention includes various types of variations and modifications realized according to all disclosed contents and technical ideas of the present description. Further, the present invention is applicable to a technical field of SDN (Software-Defined Network).

Further, in the present invention, the terminal 1, the network node (the base station (eNB) 2, the SGW 3, the PGW 4, or the MME 5), or a computer, a CPU (Central Processing Unit), or an MPU (Micro-Processing Unit) of the communication apparatus 100 may execute software (a program) for implementing the above-described functions of each example embodiment. The terminal 1 or each network node may acquire software (a program) for realizing the above-described functions of each example embodiment via various types of storage media such as a CD-R (Compact Disc Recordable) and the like or a network, for example. The terminal 1, each network node, or a program acquired by the communication apparatus 100 and a storage medium storing the program constitute the present invention. The software (the program) may be previously stored, for example, on the terminal 1, each network node, or a predetermined storage unit included in the communication apparatus 100. The terminal 1 or a computer, a CPU, an MPU, or the like of each network node may read and execute program codes of the acquired software (program). Therefore, the terminal 1, each network node, or the communication apparatus 100 executes the same processing as the processing of the terminal 1, each network node, or the communication apparatus 100 in each example embodiment described above.

This application is based upon and claims the benefit of priority from Japanese patent application No. 2015-019887, filed on Feb. 4, 2015, the disclosure of which is incorporated herein in its entirety by reference.

### REFERENCE SIGNS LIST

1, 1A, 1B, 1C Terminal
2 Base station
3 SGW
3A Virtual SGW
4 PGW
4A Virtual PGW
5 MME
5A Virtual MME
6 HSS
6A Virtual HSS
7 CSCF
7A Virtual CSCF
8 Application
8A Image analysis application
8B Map application
8C EMS application
8D Information analysis application
8E Service application
10 Message generation unit
11 Communication unit
20 Identification unit
21 Network switch unit
22 RRH
23 BBU
50 Virtual entity management unit
51 Control unit
59, 59A Access network
60 Subscriber information database
61 Control unit
62 Interface
70 S-CSCF
70A Virtual S-CSCF
71 P-CSCF
71A Virtual P-CSCF
72 I-CSCF
72A Virtual I-CSCF
100 Communication apparatus
110 Control unit
120 Virtual network function
220 Management unit
221 Communication unit
230 Management unit
231 Control unit

1. A communication apparatus comprising:
a first circuit configured to identify, based on an attribute of a terminal, a network to be connected to the terminal among a plurality of networks including a first network managed by a first operator and a second network managed by a second operator; and
a second circuit configured to process communication with the terminal in such a way that a network node that executes predetermined signal processing in the identified network and the terminal are connected to each other, wherein
the first circuit is configured to identify, for a subscriber terminal of the second operator, the second network managed by the second operator that provides a communication service by using the network node provided by the first operator.

2. The communication apparatus according to claim 1, wherein
the first circuit enables identification of, for a subscriber terminal of the second operator, the second network managed by the second operator that provides a communication service by using a wireless band provided by the first operator.

3. The communication apparatus according to claim 1, wherein
the first circuit enables identification of, for a subscriber terminal of the second operator, the second network including a virtual network node in which a function of the network node is operated by a virtual machine.

4. The communication apparatus according to claim 3, wherein
the first circuit enables identification of, for a subscriber terminal of the second operator, the second network including the virtual network node operated by a virtual machine dynamically configured based on a request condition for processing of communication data from the subscriber terminal.

5. The communication apparatus according to claim 1, wherein
the first circuit enables identification of, based on identification information that enables identification of a network to which the terminal subscribes, an attribute of the terminal.

6. The communication apparatus according to claim 1, wherein
the first circuit enables identification of, based on identification information that enables identification of an operator to which the terminal subscribes, an attribute of the terminal.

7. The communication apparatus according to claim 1, wherein
the first circuit enables identification of an attribute of the terminal, based on a PLMN ID (Public Land Mobile Network IDentifier).

8. A communication system comprising:
a terminal connectable to a network; and
a communication apparatus including
a first circuit configures to identify, based on an attribute of the terminal, a network to be connected to the terminal among a plurality of networks including a first network managed by a first operator and a second network managed by a second operator, and
a second circuit configured to process communication with the terminal in such a way that a network node that executes predetermined signal processing in the identified network and the terminal are connected to each other, wherein
the first circuit enables identification of, for a subscriber terminal of the second operator, the second network managed by the second operator that provides a communication service by using a wireless band provided by the first operator.

9. A communication method comprising:
identifying, based on an attribute of a terminal, a network to be connected to the terminal among a plurality of networks including a first network managed by a first operator and a second network managed by a second operator;
processing communication with the terminal in a such a way that a network node that executes predetermined signal processing in the identified network and the terminal are connected to each other; and
identifying, for a subscriber terminal of the second operator, the second network managed by the second operator that provides a communication service by using the network node provided by the first operator, in identification of the network corresponding to the terminal.

10. The communication method according to claim 9, further comprising
identifying, for a subscriber terminal of the second operator, the second network managed by the second operator that provides a communication service by using a wireless band provided by the first operator, in the identification of the network corresponding to the terminal.

11. The communication method according to claim 9, further comprising
identifying, for a subscriber terminal of the second operator, the second network including a virtual network node in which a function of the network node is operated by a virtual machine, in the identification of the network corresponding to the terminal.

12. The communication method according to claim 11, further comprising
identifying, for a subscriber terminal of the second operator, the second network including the virtual network node operated by a virtual machine dynamically constructed based on a request condition for processing of communication data from the subscriber terminal, in the identification of the network corresponding to the terminal.

13. The communication method according to claim 10, further comprising
identifying, based on identification information that enables identification of a network to which the terminal subscribes, an attribute of the terminal, in the identification of the network corresponding to the terminal.

14. The communication method according to claim 10, further comprising
identifying, based on identification information that enables identification of an operator to which the terminal subscribes, an attribute of the terminal, in the identification of the network corresponding to the terminal.

15. The communication method according to claim 10, further comprising
identifying an attribute of the terminal, based on a PLMN ID (Public Land Mobile Network IDentifier), in the identification of the network corresponding to the terminal.

16. (canceled)

17. The communication apparatus according to claim 2, wherein
the first circuit enables identification of, for a subscriber terminal of the second operator, the second network including a virtual network node in which a function of the network node is operated by a virtual machine.

18. The communication apparatus according to claim 2, wherein
the first circuit enables identification of, based on identification information that enables identification of a network to which the terminal subscribes, an attribute of the terminal.

19. The communication apparatus according to claim 2, wherein
the first circuit enables identification of, based on identification information that enables identification of an operator to which the terminal subscribes, an attribute of the terminal.

20. The communication apparatus according to claim 2, wherein
the first circuit enables identification of an attribute of the terminal, based on a PLMN ID (Public Land Mobile Network IDentifier).
